(19) United States
(12) Patent Application Publication
(10) Pub. No.: US 2025/0089064 A1
(43) Pub. Date: Mar. 13, 2025

(54) METHOD AND DEVICE IN NODES USED FOR WIRELESS COMMUNICATION

(71) Applicants: Zheng LIU, Shanghai (CN); Xiaobo ZHANG, Shanghai (CN)

(72) Inventors: Zheng LIU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/957,907

(22) Filed: Nov. 25, 2024

Related U.S. Application Data
(63) Continuation of application No. PCT/CN2023/096857, filed on May 29, 2023.

(30) Foreign Application Priority Data
May 30, 2022 (CN) 202210600536.1

(51) Int. Cl. H04W 72/231; H04W 72/12; H04W 72/51

(52) U.S. Cl. CPC H04W 72/231; H04W 72/12; H04W 72/51

(57) ABSTRACT

A node receives a first information block, and the first information block is used to determine W1 cell sets; a node monitors multiple PDCCH candidates; a number of serving cell(s) comprised in one of the W1 cell sets is not greater than a first threshold; one of the multiple PDCCH candidates is monitored for a first DCI format, and a first cell set is one of the W1 cell sets, and the first DCI format is used to schedule the first cell set at the same time; one of the multiple PDCCH candidates belongs to a first search space set, and an indicator value associated with the first cell set is used to determine a PDCCH candidate monitored for the first DCI format; a first quantity value is equal to a largest number among numbers of serving cell(s) respectively comprised in the W1 cell sets.

### CROSS REFERENCE TO RELATED APPLICATIONS

This application is the continuation of the international patent application No. PCT/CN2023/096857, filed on May 29, 2023, and claims the priority benefit of Chinese Patent Application CN202210600536.1. filed on May 30, 2022, the full disclosure of which is incorporated herein by reference.

### BACKGROUND

### Technical Field

The present application relates to transmission methods and devices in wireless communication systems, and in particular to a transmission method and device of a multicarrier symbol in wireless communications.

### Related Art

Application scenarios of future wireless communication systems are becoming increasingly diversified, and different application scenarios have different performance demands on systems. In order to meet different performance requirements of various application scenarios, it was decided at 3rd Generation Partner Project (3GPP) Radio Access Network (RAN) #72th plenary that a study on New Radio (NR), or what is called Fifth Generation (5G) shall be conducted. A work item of NR was approved at 3GPP RAN #75th plenary to standardize NR.

In NR technology, multicarrier (including carrier aggregation and dual connectivity) technology are important components. In order to adapt to diverse application scenarios and meet different demands, 3GPP has been evolving multicarrier technology since the Rel-15 version.

### SUMMARY

In multicarrier communications, such as Carrier Aggregation (CA), cross-carrier scheduling is supported. In networks supported by the existing standards, such as R17 and previous versions of 5G New Radio (NR), for multiple scheduled carriers, scheduling is only supported on a respectively corresponding carrier or a corresponding Physical Downlink Control Channel (PDCCH), rather than on a same PDCCH on a same carrier.

The present application discloses a solution to the problem of a same PDCCH scheduling multiple carriers at the same time in NR's multicarrier system. It should be noted that, in the description of the present application, only the PDCCH scheduling in multicarrier is taken as a typical application scenario or example; the present application is also applicable to other scenarios facing similar problems (such as other scenarios with higher requirements for controlling channel capacity, including but not limited to capacity enhancement systems, systems adopting higher frequency, coverage enhancement systems, unlicensed frequency-domain communications, Internet of Things (IoT), Ultra Reliable Low Latency Communication (URLLC) networks, Internet of Vehicles (IoV), etc.), where similar technical effects can also be achieved. Additionally, the adoption of a unified solution for various scenarios, including but not limited to scenarios of multicarrier, contributes to the reduction of hardware complexity and costs. If no conflict is incurred, embodiments in a first node in the present application and the characteristics of the embodiments are also applicable to a second node, and vice versa. Particularly, for interpretations of the terminology, nouns, functions and variants (if not specified) in the present application, refer to definitions given in TS36 series, TS38 series and TS37 series of 3GPP specifications.

The present application provides a method in a first node for wireless communications, comprising:
receiving a first information block, the first information block being used to determine W1 cell sets, any one of the W1 cell sets comprising at least one serving cell, W1 being a positive integer greater than 1; and
monitoring multiple PDCCH candidates;
herein, a number of serving cell(s) comprised in any one of the W1 cell sets is not greater than a first threshold, and the first threshold is a predefined or configurable positive integer; the multiple PDCCH candidates comprise at least one PDCCH candidate being monitored for a first DCI format, a first cell set is one of the W1 cell sets, and the first DCI format is used to schedule at least one serving cell comprised in the first cell set simultaneously; at least one of the multiple PDCCH candidates belongs to a first search space set, and at least one indicator value associated with the first cell set is used to determine a PDCCH candidate monitored for the first DCI format from the first search space set; a first quantity value is equal to a largest number among numbers of serving cell(s) respectively comprised in the W1 cell sets, and a size of the first DCI format is related to the first quantity value, the first quantity value being a positive integer.

In one embodiment, a first quantity value is equal to a largest number among numbers of serving cell(s) respectively comprised in the W1 cell sets and a first DCI format size is associated with a first quantity value, optimizing the design of the DCI format and reducing the header overhead of DCI.

According to one aspect of the present application, the above method is characterized in that the first information block is used to determine W2 cell sets, and any of the W2 cell sets comprises at least one serving cell, W2 being a positive integer greater than 1; a second quantity value is equal to a largest number among numbers of serving cell(s) respectively comprised in the W2 cell sets, the second quantity value being a positive integer; the first quantity value is used to determine a first candidate size, the second quantity value is used to determine a second candidate size, and a size of the first DCI format is equal to a larger one of the first candidate size and the second candidate size.

In one embodiment, a size of a first DCI format is equal to a larger one of the first candidate size and the second candidate size, ensuring the size alignment of the uplink and downlink DCI formats and reducing blind detection overhead.

According to one aspect of the present application, the above method is characterized in that a second DCI format is a DCI format different from the first DCI format, and the second DCI format and the first DCI format are respectively used for scheduling in different link directions; the second DCI format is used to schedule at least one serving cell in a second cell set, and the second cell set comprises multiple serving cells; when the first DCI format is used for downlink scheduling, the first cell set comprises the second cell set; when the first DCI format is used for uplink scheduling, the second cell set comprises the first cell set.

In one embodiment, uplink and downlink scheduling cells are required to be self-contained, which ensures the consistency of signaling configuration and further reduces signaling overhead.

According to one aspect of the present application, the above method is characterized in that when the first cell set comprises the second cell set, the second DCI format is used to determine the second cell set from the first cell set; when the second cell set comprises the first cell set, the first DCI format is used to determine the first cell set from the second cell set.

According to one aspect of the present application, the above method is characterized in that a reference quantity value is used to determine PDCCH candidate(s) with a first aggregation level from the first search space set, the reference quantity value being a positive integer, the first aggregation level being a positive integer; a target cell set comprises all serving cell(s) comprised in each of the W1 cell sets, and the reference quantity value is equal to a largest number of PDCCH candidate(s) with the first aggregation level respectively associated with serving cell(s) in the target cell set.

In one embodiment, a maximum number of PDCCH candidate(s) in a search space is determined according to all configured cells rather than just the scheduled cells, ensuring the honeycomb structure between PDCCH candidates and reducing the blocking probability.

According to one aspect of the present application, the above method is characterized in that one of the W1 cell sets comprises all serving cells comprised in any one of the other two cell sets in the W1 cell set.

In one embodiment, W1 cell sets is consistent with self-containment and honeycomb structure, reducing configuration signaling overhead while ensuring scheduling flexibility.

According to one aspect of the present application, the above method is characterized in comprising:
transmitting a second information block;
herein, the second information block is used to indicate a capability parameter set of a transmitter of the second information block, and the capability parameter set of the transmitter of the second information block comprises at least a first parameter and a second parameter; the first parameter is used to indicate a number of downlink serving cell(s) that is supported by the transmitter of the second information block to be scheduled by one PDCCH simultaneously, and the second parameter is used to indicate a number of uplink serving cell(s) that is supported by the transmitter of the second information block to be scheduled by one PDCCH simultaneously.

In one embodiment, a first parameter and a second parameter support independent uplink multi-cell simultaneous scheduling and downlink multi-cell simultaneous scheduling instructions, taking into account the asymmetry of UE's uplink and downlink capabilities, improving the scheduling flexibility while reducing the implementation complexity.

The present application provides a method in a second node for wireless communications, comprising:
transmitting a first information block, the first information block being used to determine W1 cell sets, any one of the W1 cell sets comprising at least one serving cell, W1 being a positive integer greater than 1; and
determining multiple PDCCH candidates;
herein, a number of serving cell(s) comprised in any one of the W1 cell sets is not greater than a first threshold, and the first threshold is a predefined or configurable positive integer; the multiple PDCCH candidates comprise at least one PDCCH candidate being monitored for a first DCI format, a first cell set is one of the W1 cell sets, and the first DCI format is used to schedule at least one serving cell comprised in the first cell set simultaneously; at least one of the multiple PDCCH candidates belongs to a first search space set, and at least one indicator value associated with the first cell set is used to determine a PDCCH candidate monitored for the first DCI format from the first search space set; a first quantity value is equal to a largest number among numbers of serving cell(s) respectively comprised in the W1 cell sets, and a size of the first DCI format is related to the first quantity value, the first quantity value being a positive integer.

According to one aspect of the present application, the above method is characterized in that the first information block is used to determine W2 cell sets, and any of the W2 cell sets comprises at least one serving cell, W2 being a positive integer greater than 1; a second quantity value is equal to a largest number among numbers of serving cell(s) respectively comprised in the W2 cell sets, the second quantity value being a positive integer; the first quantity value is used to determine a first candidate size, the second quantity value is used to determine a second candidate size, and a size of the first DCI format is equal to a larger one of the first candidate size and the second candidate size.

According to one aspect of the present application, the above method is characterized in that a second DCI format is a DCI format different from the first DCI format, and the second DCI format and the first DCI format are respectively used for scheduling in different link directions; the second DCI format is used to schedule at least one serving cell in a second cell set, and the second cell set comprises multiple serving cells; when the first DCI format is used for downlink scheduling, the first cell set comprises the second cell set; when the first DCI format is used for uplink scheduling, the second cell set comprises the first cell set.

According to one aspect of the present application, the above method is characterized in that when the first cell set comprises the second cell set, the second DCI format is used to determine the second cell set from the first cell set; when the second cell set comprises the first cell set, the first DCI format is used to determine the first cell set from the second cell set.

According to one aspect of the present application, the above method is characterized in that a reference quantity value is used to determine PDCCH candidate(s) with a first aggregation level from the first search space set, the reference quantity value being a positive integer, the first aggregation level being a positive integer; a target cell set comprises all serving cell(s) comprised in each of the W1 cell sets, and the reference quantity value is equal to a largest number of PDCCH candidate(s) with the first aggregation level respectively associated with serving cell(s) in the target cell set.

According to one aspect of the present application, the above method is characterized in that one of the W1 cell sets comprises all serving cells comprised in any one of the other two cell sets in the W1 cell set.

According to one aspect of the present application, the above method is characterized in comprising:
receiving a second information block;
herein, the second information block is used to indicate a capability parameter set of a transmitter of the second information block, and the capability parameter set of the transmitter of the second information block comprises at least a first parameter and a second parameter; the first parameter is used to indicate a number of downlink serving cell(s) that is supported by the transmitter of the second information block to be scheduled by one PDCCH simultaneously, and the second parameter is used to indicate a number of uplink serving cell(s) that is supported by the transmitter of the second information block to be scheduled by one PDCCH simultaneously.

The present application provides a first node for wireless communications, comprising:
a first transceiver, receiving a first information block, the first information block being used to determine W1 cell sets, any one of the W1 cell sets comprising at least one serving cell, W1 being a positive integer greater than 1; and
a first receiver, monitoring multiple PDCCH candidates;
herein, a number of serving cell(s) comprised in any one of the W1 cell sets is not greater than a first threshold, and the first threshold is a predefined or configurable positive integer; the multiple PDCCH candidates comprise at least one PDCCH candidate being monitored for a first DCI format, a first cell set is one of the W1 cell sets, and the first DCI format is used to schedule at least one serving cell comprised in the first cell set simultaneously; at least one of the multiple PDCCH candidates belongs to a first search space set, and at least one indicator value associated with the first cell set is used to determine a PDCCH candidate monitored for the first DCI format from the first search space set; a first quantity value is equal to a largest number among numbers of serving cell(s) respectively comprised in the W1 cell sets, and a size of the first DCI format is related to the first quantity value, the first quantity value being a positive integer.

The present application provides a second node for wireless communications, comprising:
a second transceiver, transmitting a first information block, the first information block being used to determine W1 cell sets, any one of the W1 cell sets comprising at least one serving cell, W1 being a positive integer greater than 1; and
a first transmitter, determining multiple PDCCH candidates;
herein, a number of serving cell(s) comprised in any one of the W1 cell sets is not greater than a first threshold, and the first threshold is a predefined or configurable positive integer; the multiple PDCCH candidates comprise at least one PDCCH candidate being monitored for a first DCI format, a first cell set is one of the W1 cell sets, and the first DCI format is used to schedule at least one serving cell comprised in the first cell set simultaneously; at least one of the multiple PDCCH candidates belongs to a first search space set, and at least one indicator value associated with the first cell set is used to determine a PDCCH candidate monitored for the first DCI format from the first search space set; a first quantity value is equal to a largest number among numbers of serving cell(s) respectively comprised in the W1 cell sets, and a size of the first DCI format is related to the first quantity value, the first quantity value being a positive integer.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first information block and multiple PDCCH candidates according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first node and a second node according to one embodiment of the present application;

FIG. 5 illustrates a flowchart of radio signal transmission according to one embodiment of the present application;

FIG. 6 illustrates a schematic diagram of a first quantity value and a second quantity value according to one embodiment of the present application;

FIG. 7 illustrates a schematic diagram of a relation between a first cell set and a second cell set according to one embodiment of the present application;

FIG. 8 illustrates a schematic diagram of a relation between a first DCI format and a second DCI format according to one embodiment of the present application;

FIG. 9 illustrates a schematic diagram of a reference quantity value according to one embodiment of the present application;

FIG. 10 illustrates a schematic diagram of W1 cell sets according to one embodiment of the present application;

FIG. 11 illustrates a schematic diagram of a first parameter and a second parameter according to one embodiment of the present application;

FIG. 12 illustrates a structure block diagram of a processor in a first node according to one embodiment of the present application;

FIG. 13 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart 100 of a first information block and multiple PDCCH candidates according to one embodiment of the present application, as shown in FIG. 1. In FIG. 1, each box represents a step, and it is particularly important to emphasize that the order of the individual boxes in the figure does not limit the temporal sequential relation between the steps represented.

In embodiment 1, a first node in the present application receives a first information block in step 101, the first information block is used to determine W1 cell sets, any one of the W1 cell sets comprises at least one serving cell, W1 being a positive integer greater than 1; the first node in the present application monitors multiple PDCCH candidates in step 102; herein, a number of serving cell(s) comprised in any one of the W1 cell sets is not greater than a first threshold, and the first threshold is a predefined or configurable positive integer; the multiple PDCCH candidates comprise at least one PDCCH candidate being monitored for a first DCI format, a first cell set is one of the W1 cell sets, and the first DCI format is used to schedule at least one serving cell comprised in the first cell set simultaneously; at least one of the multiple PDCCH candidates belongs to a first search space set, and at least one indicator value associated with the first cell set is used to determine a PDCCH candidate monitored for the first DCI format from the first search space set; a first quantity value is equal to a largest number among numbers of serving cell(s) respectively comprised in the W1 cell sets, and a size of the first DCI format is related to the first quantity value, the first quantity value being a positive integer.

In one embodiment, the first information is transmitted via an air interface or a radio interface.

In one embodiment, the first information block comprises all or part of a higher-layer signaling or a physical-layer signaling.

In one embodiment, the first information block comprises all or part of a Radio Resource Control (RRC)-layer signaling, or the first information block comprises all or part of a Medium Access Control (MAC)-layer signaling.

In one embodiment, the first information block comprises all or part of a System Information Block (SIB).

In one embodiment, the first information block is UE-specific.

In one embodiment, the first information block is configured per carrier, or per BWP (bandwidth part), or per search space.

In one embodiment, the first information block is configured per band or per Frequency Range (FR).

In one embodiment, the first information block comprises all or partial fields in Information Element (IE) “CellGroupConfig”.

In one embodiment, the first information block comprises field “secondaryCellGroup”, or the first information block comprises field “masterCellGroup”.

In one embodiment, the first information block is configured per Cell group, or per Physical Uplink Control Channel (PUCCH) group.

In one embodiment, the first information block comprises all or partial fields in IE “ServingCellConfig”, or all or partial fields in IE “BWP-Downlink”, or all or partial fields in IE “crossCarrierSchedulingConfig”, or all or partial fields in IE “PDCCH-ServalingCellConfig”.

In one embodiment, the first information block comprises all or partial fields in IE “pdcch-ConfigCommon”.

In one embodiment, the first information block comprises all or partial fields in IE “BWP-DownlinkCommon”.

In one embodiment, the first information block comprises all or partial fields in IE “BWP-DownlinkDedicated”.

In one embodiment, the first information block comprises all or partial fields in IE “pdcch-Config”.

In one embodiment, the first information block comprises all or partial fields in IE “SearchSpace”.

In one embodiment, the first information block comprises all or partial fields in IE “SearchSpaceExt-v1800”, or the first information block comprises all or partial fields in IE “SearchSpaceExt2-r18”.

In one embodiment, the first information block comprises all or partial fields in a Downlink Control Information (DCI) format.

In one embodiment, the technical feature that “the first information block is used to determine W1 cell sets” includes the following meaning: part or all of the first information block is used to explicitly or implicitly indicate the W1 cell sets.

In one embodiment, the technical feature that “the first information block is used to determine W1 cell sets” includes the following meaning: part or all of the first information block is used to explicitly or implicitly indicate a list composed of W1 cell sets.

In one embodiment, the technical feature that “the first information block is used to determine W1 cell sets” includes the following meaning: part or all of the first information block is used to explicitly or implicitly indicate serving cell(s) comprised in W1 cell sets.

In one embodiment, the technical feature that “the first information block is used to determine W1 cell sets” includes the following meaning: part or all of the first information block is used to explicitly or implicitly add the W1 cell sets into a list.

In one embodiment, the technical feature that “the first information block is used to determine W1 cell sets” includes the following meaning: part or all of the first information block is used to explicitly or implicitly release a cell set to obtain a list consisting of W1 cell sets.

In one embodiment, the technical feature that “the first information block is used to determine W1 cell sets” includes the following meaning: part or all of the first information block is used to explicitly or implicitly add serving cells to form one of the W1 cell sets.

In one embodiment, the technical feature that “the first information block is used to determine W1 cell sets” includes the following meaning: part or all of the first information block is used to explicitly or implicitly release a serving cell to obtain one of the W1 cell sets.

In one embodiment, the technical feature that “the first information block is used to determine W1 cell sets” includes the following meaning: part or all of the first information block is used to explicitly or implicitly indicate a number of serving cell(s) comprised in at least one of the W1 cell sets.

In one embodiment, the technical feature that “the first information block is used to determine W1 cell sets” includes the following meaning: part or all of the first information block is used to explicitly or implicitly indicate an upper limit of a number of serving cell(s) comprised in at least one of the W1 cell sets.

In one embodiment, the technical feature that “the first information block is used to determine W1 cell sets” includes the following meaning: all or part of the first information block is used to explicitly or implicitly indicate all serving cells comprised together in the W1 cell sets, and all serving cells comprised together in the W1 cell sets consist the W1 cell sets according to predefined rules.

In one embodiment, the technical feature that “the first information block is used to determine W1 cell sets” includes the following meaning: all or part of the first information block is used to explicitly or implicitly indicate the target cell set in the present application, and all serving cells comprised in the target cell set form the W1 cell sets according to predefined rules.

In one embodiment, the technical feature that “the first information block is used to determine W1 cell sets” includes the following meaning: all or part of the first information block is used to explicitly or implicitly indicate all serving cells comprised together in the W1 cell sets, and all serving cells comprised together in the W1 cell sets are indexed in order according to 0, . . . , N_{cell}−1, where N_{cell} denotes a total number of all serving cells comprised together in the W1 cell sets, d^{(Q)} denotes a cell set comprising Q serving cell(s) in the W1 cell sets, and an index of a serving cell comprised in cell set d^{(Q)} satisfies

$$Q \cdot \{ ⌊ \frac{{d}^{( Q )} \cdot {N}_{cell}}{Q \cdot {M}^{( Q )}} ⌋ mod ⌊ {N}_{cell} / Q ⌋ \} + q$$

herein, q=0, . . . , Q−1, M^{(Q)} denotes a number of cell set(s) comprising Q serving cell(s) in the W1 cell sets.

In one embodiment, the technical feature that “the first information block is used to determine W1 cell sets” includes the following meaning: all or part of the first information block is used to explicitly or implicitly indicate the target cell set in the present application, and all serving cells comprised in the target cell set are indexed in order according to 0, . . . , N_{cell}−1, where N_{cell} denotes a total number of all serving cells comprised in the target cell set, d^{(Q)} denotes a cell set comprising Q serving cell(s) in the W1 cell sets, and an index of a serving cell comprised in cell set d^{(Q)} satisfies

$$Q \cdot \{ ⌊ \frac{{d}^{( Q )} \cdot {N}_{cell}}{Q \cdot {M}^{( Q )}} ⌋ mod ⌊ {N}_{cell} / Q ⌋ \} + q$$

herein, q=0, . . . , Q−1, M^{(Q)} denotes a number of cell set(s) comprising Q serving cell(s) in the W1 cell sets.

In one embodiment, the W1 cell sets consist of a cell set list.

In one embodiment, any serving cell comprised in any one of the W1 cell sets is a serving cell that can transmit a Physical Downlink Shared Channel (PDSCH).

In one embodiment, any serving cell comprised in any one of the W1 cell sets is a serving cell that can transmit a Physical Uplink Shared Channel (PUSCH).

In one embodiment, any two of the W1 cell sets are different.

In one embodiment, there exist two of the W1 cell sets being the same.

In one embodiment, any one of the W1 cell sets is a set of serving cells that can be scheduled by a DCI format or a PDCCH at the same time.

In one embodiment, any one of the W1 cell sets is a set of serving cells to which PDSCHs that can be scheduled by a DCI format or a PDCCH at the same time belong respectively.

In one embodiment, any one of the W1 cell sets is a set of serving cells to which PUSCHs that can be scheduled by a DCI format or a PDCCH at the same time belong respectively.

In one embodiment, any one of the W1 cell sets is a list of serving cells.

In one embodiment, all serving cells comprised in one of the W1 cell sets belong to a same frequency band.

In one embodiment, all serving cells comprised in one of the W1 cell sets belong to a same frequency range (FR).

In one embodiment, all serving cells comprised in one of the W1 cell sets adopt a same duplex mode (TDD, Time Division Duplexing or FDD, Frequency Division Duplexing).

In one embodiment, one of the W1 cell sets comprises two intra-band serving cells.

In one embodiment, one of the W1 cell sets comprises two inter-band serving cells.

In one embodiment, one of the W1 cell sets comprises two serving cells respectively belonging to two different frequency bands.

In one embodiment, two serving cells comprised in one of the W1 cell sets respectively belong to two different frequency ranges.

In one embodiment, two serving cells comprised in one of the W1 cell sets respectively adopt different duplex modes (TDD or FDD).

In one embodiment, all serving cells outside a self-scheduling cell comprised in any one of the W1 cell sets belong to a same frequency band.

In one embodiment, all serving cells outside a self-scheduling cell comprised in any one of the W1 cell sets belong to a same frequency range.

In one embodiment, all serving cells outside a self-scheduling cell comprised in any one of the W1 cell sets adopt a same duplex mode (TDD or FDD).

In one embodiment, any one of the W1 cell sets comprises multiple serving cells.

In one embodiment, there exists at least one cell set in the W1 cell sets only comprising one serving cell.

In one embodiment, any of the multiple PDCCH candidates comprises a PDCCH DMRS (demodulation reference signal).

In one embodiment, part or all of the first information block in the present application is used to explicitly or implicitly determine the multiple PDCCH candidates.

In one embodiment, a signaling outside the first information block in the present application is used to determine the multiple PDCCH candidates.

In one embodiment, a PDCCH configuration signaling is used to determine the multiple PDCCH candidates.

In one embodiment, the multiple PDCCH candidates all belong to a same given time window in time domain.

In one embodiment, the multiple PDCCH candidates all belong to a same slot or span in time domain.

In one embodiment, the multiple PDCCH candidates all belong to a same time window composed of multiple continuous slots in time domain.

In one embodiment, the multiple PDCCH candidates comprise all or partial PDCCH candidates monitored by the first node within a time window.

In one embodiment, the multiple PDCCH candidates comprise all or partial PDCCH candidates configured within a time window.

In one embodiment, a number of CCE(s) occupied by any of the multiple PDCCH candidates is equal to one of 1, 2, 4, 8, or 16.

In one embodiment, any of the multiple PDCCH candidates is a monitored PDCCH candidate.

In one embodiment, any of the multiple PDCCH candidates is a PDCCH candidate for one or multiple DCI formats.

In one embodiment, any of the multiple PDCCH candidates is a PDCCH candidate for one or more DCI payload sizes.

In one embodiment, the multiple PDCCH candidates comprise two candidates for a same DCI format.

In one embodiment, DCI formats to which any two of the multiple PDCCH candidates are for are different.

In one embodiment, the multiple PDCCH candidates comprise two candidates for an equal DCI format size.

In one embodiment, the multiple PDCCH candidates only comprises one PDCCH being monitored for the first DCI format.

In one embodiment, the multiple PDCCH candidates comprise more than one PDCCH candidate being monitored for the first DCI format.

In one embodiment, indices of any two of the multiple PDCCH candidates are not equal.

In one embodiment, the multiple PDCCH candidates comprise two PDCCH candidates with equal indices.

In one embodiment, there exist two of the multiple PDCCH candidates occupying a same CCE set.

In one embodiment, there do not exist two of the multiple PDCCH candidates occupying a same CCE set.

In one embodiment, a number of CCEs occupied by any one of the multiple PDCCH candidates is equal to an aggregation level (AL) of the PDCCH candidate.

In one embodiment, any one CCE occupied by any one of the multiple PDCCH candidates comprises 6 REGs (resource element groups).

In one embodiment, any one CCE occupied by any one of the multiple PDCCH candidates comprises an RE occupied by a PDCCH DMRS.

In one embodiment, two statements of “monitoring multiple PDCCH candidates” and “decoding each PDCCH candidate in multiple PDCCH candidates” are equivalent or interchangeable.

In one embodiment, two statements of “monitoring multiple PDCCH candidates” and “blindly decoding each PDCCH candidate in multiple PDCCH candidates” are equivalent or interchangeable.

In one embodiment, statements of “monitoring multiple PDCCH candidates” and “performing decoding and CRC checking on each PDCCH candidate in multiple PDCCH candidates” are equivalent or interchangeable.

In one embodiment, statements of “monitoring multiple PDCCH candidates” and “performing decoding and CRC check scrambled by an RNTI (Radio Network Temporary Identity) on each PDCCH candidate in multiple PDCCHs” are equivalent or interchangeable.

In one embodiment, two statements of “monitoring multiple PDCCH candidates” and “decoding each of multiple PDCCH candidates for monitored DCI format(s)” are equivalent or interchangeable.

In one embodiment, two statements of “monitoring multiple PDCCH candidates” and “decoding each of multiple PDCCH candidates for monitored one or more DCI formats” are equivalent or interchangeable.

In one embodiment, two statements of “monitoring multiple PDCCH candidates” and “decoding each of multiple PDCCH candidates for monitored one or more DCI payload sizes” are equivalent or interchangeable.

In one embodiment, “the first threshold being a pre-defined or configurable positive integer” comprises the meaning: the first threshold is equal to 8.

In one embodiment, “the first threshold being a pre-defined or configurable positive integer” comprises the meaning: the first threshold is equal to 4.

In one embodiment, “the first threshold being a pre-defined or configurable positive integer” comprises the meaning: the first threshold is equal to 3.

In one embodiment, “the first threshold being a pre-defined or configurable positive integer” comprises the meaning: the first threshold is not less than 3.

In one embodiment, “the first threshold being a pre-defined or configurable positive integer” comprises the meaning: the first threshold is related to a link direction scheduled by the first DCI format.

In one embodiment, “the first threshold being a pre-defined or configurable positive integer” comprises the meaning: the first threshold is related to whether the W1 cell sets are used for PDSCH transmission or PUSCH transmission.

In one embodiment, “the first threshold being a pre-defined or configurable positive integer” comprises the meaning: all or part of the first information block is used to explicitly or implicitly indicate the first threshold.

In one embodiment, “the first threshold being a pre-defined or configurable positive integer” comprises the meaning: all or part of the first information block is used to explicitly or implicitly indicate a link direction corresponding to the W1 cell sets, and a link direction corresponding to the W1 cell sets is used to determine the first threshold.

In one embodiment, “the first threshold being a pre-defined or configurable positive integer” comprises the meaning: all or part of the first information block is used to explicitly or implicitly indicate whether the W1 cell sets correspond to a PDSCH or a PUSCH; when the W1 cell sets corresponds to a PDSCH, the first threshold is equal to a first candidate threshold; when the W1 cell sets corresponds to a PUSCH, the first threshold is equal to a second candidate threshold; the first candidate threshold is equal to a fixed value or a configurable value or a value of a capability report of the first node, and the second candidate threshold is equal to a fixed value or a configurable value or a value of a capacity report of the first node. In one subsidiary embodiment of the above embodiment, the second candidate threshold is not greater than the first candidate threshold. In one subsidiary embodiment of the above embodiment, the first candidate threshold is not less than 3, and the second candidate threshold is not less than 3. In one subsidiary embodiment of the above embodiment, the first candidate threshold is equal to 8, and the second candidate threshold is equal to 4. In one embodiment, the first candidate threshold is equal to 4, and the second candidate threshold is equal to 3.

In one embodiment, a number of serving cell(s) comprising PDSCH(s) scheduled by a DCI format or a PDCCH at the same time and supported by a capability of the first node is not greater than the first threshold.

In one embodiment, a number of serving cell(s) comprising PUSCH(s) scheduled by a DCI format or a PDCCH at the same time and supported by a capability of the first node is not greater than the first threshold.

In one embodiment, a number of serving cell(s) scheduled by a DCI format or a PDCCH at the same time and supported by a capability of the first node is not greater than the first threshold.

In one embodiment, regardless of whether the W1 cell sets comprise PDSCH(s) or PUSCH(s) scheduled by a DCI format or a PDCCH at the same time, the first threshold remains unchanged.

In one embodiment, a number of serving cell(s) comprised in any one of the W1 cell sets is not greater than a number of serving cell(s) comprising PDSCH(s) scheduled by a DCI format or a PDCCH at the same time and supported by a capability of the first node.

In one embodiment, a number of serving cell(s) comprised in any one of the W1 cell sets is not greater than a number of serving cell(s) comprising PUSCH(s) scheduled by a DCI format or a PDCCH at the same time and supported by a capability of the first node.

In one embodiment, a number of serving cell(s) comprised in any one of the W1 cell sets is not greater than a number of serving cell(s) scheduled by a DCI format or a PDCCH at the same time and supported by a capability of the first node.

In one embodiment, there exists a number of serving cell(s) comprised in one of the W1 cell sets being equal to the first threshold.

In one embodiment, a number of serving cell(s) comprised in any one of the W1 cell sets is less than the first threshold.

In one embodiment, a total number of serving cell(s) comprised in any one of the W1 cell sets is not greater than the first threshold.

In one embodiment, the first DCI format is one of 0_2 or 1_2, or the first DCI format is one of 0_K or 1_K, or the first DCI format is one of 0_2, 0_K, 1_2 and 1_K, or the first DCI format is one of 0_1, 0_2, 0_K, 1_1, 1_2 and 1_K, or the first DCI format is one of 0_1, 0_2, 1_1 and 1_2; or the first DCI format is one of 0_0, 0_1, 1_0 and 1_1; or the first DCI format is one of 0_0 and 1_0; or the first DCI format is one of 0_0, 0_1, 0_2, 1_0, 1_1 and 1_2; or the first DCI format is one of 0_0, 0_1, 0_2, 0_K, 1_0, 1_1, 1_2, and 1_K; where K is a positive integer greater than 2. In one subsidiary embodiment of the above embodiment, K is equal to 3. In one subsidiary embodiment of the above embodiment, K is equal to 4. In one subsidiary embodiment of the above embodiment, K is equal to 5.

In one embodiment, a DCI format combination to which the first DCI format belongs is pre-defined or configured.

In one embodiment, a DCI format combination to which the first DCI format belongs is configured through a PDCCH configuration signaling.

In one embodiment, a DCI format combination to which the first DCI format belongs is configured through a configuration signaling of the first search space.

In one embodiment, the first DCI format is a DCI format scheduling an uplink channel or signal.

In one embodiment, the first DCI format is a DCI format scheduling a downlink channel or signal.

In one embodiment, the first DCI format is one of DCI formats supported by a UE-Specific Search Set (USS set).

In one embodiment, any serving cell scheduled by the first DCI format is a serving cell scheduled by a PDCCH generated by the first DCI format.

In one embodiment, any serving cell scheduled by the first DCI format is a serving cell scheduled by a PDCCH carrying the first DCI format.

In one embodiment, any serving cell scheduled by the first DCI format is a serving cell to which at least one channel or signal scheduled by the first DCI format belongs.

In one embodiment, any serving cell scheduled by the first DCI format is configured as a serving cell scheduled by the first DCI format.

In one embodiment, any serving cell scheduled by the first DCI format is a serving cell whose downlink assignment or uplink grant is comprised in the first DCI format.

In one embodiment, the first DCI format is used to indicate the first cell set.

In one embodiment, the first DCI format is used to indicate the first cell set from multiple cell sets.

In one embodiment, a number of serving cell(s) actually scheduled by the first DCI format at the same time is greater than 1.

In one embodiment, the technical feature that “the multiple PDCCH candidates comprise at least one PDCCH candidate being monitored for a first DCI format” includes the following meanings: the multiple PDCCH candidates comprise at least one PDCCH candidate performing decoding according to the first DCI format.

In one embodiment, the technical feature that “the multiple PDCCH candidates comprise at least one PDCCH candidate being monitored for a first DCI format” includes the following meanings: the multiple PDCCH candidates comprise at least one PDCCH candidate being assumed to carry the first DCI format.

In one embodiment, the technical feature that “the multiple PDCCH candidates comprise at least one PDCCH candidate being monitored for a first DCI format” includes the following meanings: the multiple PDCCH candidates comprise at least one PDCCH candidate performing decoding according to a size of the first DCI format.

In one embodiment, the technical feature that “the multiple PDCCH candidates comprise at least one PDCCH candidate being monitored for a first DCI format” includes the following meanings: the multiple PDCCH candidates comprise at least one PDCCH candidate being assumed to be generated by a payload in the first DCI format.

In one embodiment, the technical feature that “the multiple PDCCH candidates comprise at least one PDCCH candidate being monitored for a first DCI format” includes the following meanings: the multiple PDCCH candidates comprise at least one PDCCH candidate being assumed to be occupied by a PDCCH generated by the first DCI.

In one embodiment, the technical feature that “the multiple PDCCH candidates comprise at least one PDCCH candidate being monitored for a first DCI format” includes the following meanings: the multiple PDCCH candidates comprise at least one PDCCH candidate being for decoding of the first DCI format.

In one embodiment, the technical feature that “the multiple PDCCH candidates comprise at least one PDCCH candidate being monitored for a first DCI format” includes the following meanings: the multiple PDCCH candidates comprise at least one PDCCH candidate being associated with the first DCI format.

In one embodiment, the multiple PDCCH candidates comprise at least one PDCCH candidate only being monitored for the first DCI format.

In one embodiment, the multiple PDCCH candidates comprise at least one PDCCH candidate only being monitored for a size of the first DCI format.

In one embodiment, the multiple PDCCH candidates comprise at least one PDCCH candidate being monitored for the first DCI format and a DCI format other than the first DCI format at the same time.

In one embodiment, the multiple PDCCH candidates comprise at least one PDCCH candidate being monitored for a size of the first DCI format and a size other than a size of the first DCI format at the same time. In one embodiment, the first cell set is a given cell set in the W1 cell sets.

In one embodiment, the first cell set is any cell set in the W1 cell sets.

In one embodiment, the first cell set is a predefined or configurable cell set in the W1 cell sets.

In one embodiment, all or part of the first DCI format is used to explicitly or implicitly indicate the first cell set from the W1 cell sets.

In one embodiment, all or part of the first information block is used to explicitly or implicitly indicate the first cell set from the W1 cell sets.

In one embodiment, all or part of a signaling other than the first information block is used to explicitly or implicitly indicate the first cell set from the W1 cell sets.

In one embodiment, the technical feature that “the first DCI format is used to schedule at least one serving cell comprised in the first cell set at the same time” includes the following meaning: the first DCI format is used to schedule all serving cells comprised in the first cell set at the same time.

In one embodiment, the technical feature that “the first DCI format is used to schedule at least one serving cell comprised in the first cell set at the same time” includes the following meaning: the first DCI format is configured by a higher-layer signaling or a higher-layer parameter to schedule all serving cells comprised in the first cell set at the same time, and the first DCI format actually schedules all or partial serving cells comprised in the first cell set.

In one embodiment, the technical feature that “the first DCI format is used to schedule at least one serving cell comprised in the first cell set at the same time” includes the following meaning: the first DCI format at most can schedule all serving cells comprised in the first cell set at the same time.

In one embodiment, the technical feature that “the first DCI format is used to schedule at least one serving cell comprised in the first cell set at the same time” includes the following meaning: a downlink assignment or uplink grant of all serving cells comprised in the first cell set can be comprised in the first DCI format at the same time.

In one embodiment, the technical feature that “the first DCI format is used to schedule at least one serving cell comprised in the first cell set at the same time” includes the following meaning: all or part of the first DCI format is used to explicitly or implicitly indicate the first cell set and the first DCI format schedules all serving cells comprised in the first cell set at the same time.

In one embodiment, the technical feature that “the first DCI format is used to schedule at least one serving cell comprised in the first cell set at the same time” includes the following meaning: the first DCI format actually schedules only partial serving cells comprised in the first cell set at the same time.

In one embodiment, the technical feature that “the first DCI format is used to schedule at least one serving cell comprised in the first cell set at the same time” includes the following meaning: the first DCI format actually schedules only partial serving cells comprised in the first cell set at the same time, and the first DCI format is used to indicate only partial serving cells actually scheduled in the first cell set.

In one embodiment, the technical feature that “the first DCI format is used to schedule at least one serving cell comprised in the first cell set at the same time” includes the following meaning: the first DCI format is used to schedule PDSCH(s) (Physical Downlink Shared Channel) or PUSCH(s) (Physical Uplink Shared Channel) respectively on at least one serving cell comprised in the first cell set at the same time.

In one embodiment, the technical feature that “the first DCI format is used to schedule at least one serving cell comprised in the first cell set at the same time” includes the following meaning: the first DCI format is used to schedule downlink channel(s) or downlink signal(s) respectively on at least one serving cell comprised in the first cell set at the same time.

In one embodiment, the technical feature that “the first DCI format is used to schedule at least one serving cell comprised in the first cell set at the same time” includes the following meaning: the first DCI format is used to schedule uplink channel(s) or uplink signal(s) respectively on at least one serving cell comprised in the first cell set at the same time.

In one embodiment, the first DCI format actually schedules all serving cells comprised in the first cell set at the same time.

In one embodiment, the first DCI format actually schedules partial serving cells comprised in the first cell set at the same time.

In one embodiment, one or more fields comprised in the first DCI format are used to explicitly or implicitly indicate serving cell(s) in the first cell set actually scheduled by the first DCI format at the same time.

In one embodiment, the multiple PDCCH candidates all belong to the first search space set.

In one embodiment, only a part of the multiple PDCCH candidates belong to the first search space set.

In one embodiment, only a part of PDCCH candidates in the first search space set are monitored.

In one embodiment, all PDCCH candidates in the first search space set are monitored.

In one embodiment, the first search space set is a USS.

In one embodiment, the first search space set is a USS configured with the first DCI format.

In one embodiment, the first search space set is a USS specifically for one DCI or one PDCCH scheduling multiple cells at the same time.

In one embodiment, the first search space set is a USS supporting one DCI or one PDCCH only scheduling one cell and one DCI or one PDCCH scheduling multiple cells at the same time.

In one embodiment, the first search space set is a PDCCH candidate set.

In one embodiment, the first search space set is a search space set configured by a search space configuration.

In one embodiment, the first search space set is a search space in a PDCCH configuration.

In one embodiment, an index of the first search space set belongs is equal to 0.

In one embodiment, an index of the first search space set belongs is greater than 0.

In one embodiment, the technical feature that “at least one of the multiple PDCCH candidates belongs to a first search space set” includes the following meanings: any of the multiple PDCCH candidates is a PDCCH candidate comprised in the first search space set.

In one embodiment, the technical feature that “at least one of the multiple PDCCH candidates belongs to a first search space set” includes the following meanings: part of the multiple PDCCH candidates is a PDCCH candidate comprised in the first search space set.

In one embodiment, the technical feature that “at least one of the multiple PDCCH candidates belongs to a first search space set” includes the following meanings: at least one of the multiple PDCCH candidates is determined through a configured signaling of the first search space set.

In one embodiment, the technical feature that “at least one of the multiple PDCCH candidates belongs to a first search space set” includes the following meanings: at least one of the multiple PDCCH candidates is a PDCCH candidate in the form of the first search space set.

In one embodiment, the technical feature that “at least one of the multiple PDCCH candidates belongs to a first search space set” includes the following meanings: at least one of the multiple PDCCH candidates is a PDCCH candidate comprised in the first search space set within a time window.

In one embodiment, the technical feature that “at least one of the multiple PDCCH candidates belongs to a first search space set” includes the following meanings: at least one of the multiple PDCCH candidates is a PDCCH candidate comprised in the first search space set within a slot.

In one embodiment, the technical feature that “at least one of the multiple PDCCH candidates belongs to a first search space set” includes the following meanings: at least one of the multiple PDCCH candidates is a PDCCH candidate comprised in the first search space set within a span.

In one embodiment, the technical feature that “at least one of the multiple PDCCH candidates belongs to a first search space set” includes the following meanings: at least one of the multiple PDCCH candidates is a PDCCH candidate comprised by the first search space set within a time window consists of multiple continuous slots in time domain.

In one embodiment, the technical feature that “at least one of the multiple PDCCH candidates belongs to a first search space set” includes the following meanings: at least one of the multiple PDCCH candidates is associated with the first search space set.

In one embodiment, the technical feature that “at least one of the multiple PDCCH candidates belongs to a first search space set” includes the following meanings: at least one of the multiple PDCCH candidates is associated with an index or identifier of the first search space set.

In one embodiment, the technical feature that “at least one of the multiple PDCCH candidates belongs to a first search space set” includes the following meanings: configuration parameters used to determine at least one of the multiple PDCCH candidates and an index or identifier of the first search space set are determined through a same IE.

In one embodiment, an indicator value associated with the first cell set is a CIF (Carrier Indicator Field) value.

In one embodiment, an indicator value associated with the first cell set is an index value or an identity value of the first cell set.

In one embodiment, an indicator value associated with the first cell set is an indicator value, index value, or identity value configured to the first cell set.

In one embodiment, an indicator value associated with the first cell set is a value explicitly or implicitly indicated by all or partial fields comprised in the first DCI format.

In one embodiment, the first cell set is only associated with one indicator value.

In one embodiment, the first cell set is associated with multiple indicator values.

In one embodiment, an indicator value associated with the first cell set is independent of a value configured by CIF.

In one embodiment, at least one indicator value associated with the first cell set is equal to a default value or a predefined value.

In one embodiment, there exists an indicator value in at least one indicator value associated with the first cell set being equal to 0.

In one embodiment, any indicator value in at least one indicator value associated with the first cell set is greater than 0.

In one embodiment, any indicator value in at least one indicator value associated with the first cell set is a non-negative integer.

In one embodiment, all or part of the first information block is used to explicitly or implicitly indicate the at least one indicator value associated with the first cell set.

In one embodiment, an information block other than the first information block is used to explicitly or implicitly indicate at least one indicator value associated with the first cell set.

In one embodiment, any indicator value in at least one indicator value associated with the first cell set is not greater than 31.

In one embodiment, there exists one indicator value in at least one indicator value associated with the first cell set being greater than 7.

In one embodiment, any indicator value in at least one indicator value associated with the first cell set is greater than 7.

In one embodiment, any indicator value in at least one indicator value associated with the first cell set is greater than 31.

In one embodiment, a value range for any of at least one indicator value associated with the first cell set is predefined or configurable.

In one embodiment, a value range for any one of at least one indication value associated with the first cell set is related to the release of the protocol.

In one embodiment, the technical feature that “at least one indicator value associated with the first cell set is used to determine a PDCCH candidate monitored for the first DCI format from the first search space set” includes the following meaning: at least one indicator value associated with the first cell set is used by the first node or the second node in the present application to determine a PDCCH candidate monitored for the first DCI format from the first search space set.

In one embodiment, the technical feature that “at least one indicator value associated with the first cell set is used to determine a PDCCH candidate monitored for the first DCI format from the first search space set” includes the following meaning: an indicator value, index value, or identity value configured for the first cell set is used to determine a PDCCH candidate monitored for the first DCI format from the first search space set.

In one embodiment, the technical feature that “at least one indicator value associated with the first cell set is used to determine a PDCCH candidate monitored for the first DCI format from the first search space set” includes the following meaning: at least one serving cell comprised in the first cell set being a configured indicator value, an index value, or an identity value is used to determine a PDCCH candidate monitored for the first DCI format from the first search space set.

In one embodiment, the technical feature that “at least one indicator value associated with the first cell set is used to determine a PDCCH candidate monitored for the first DCI format from the first search space set” includes the following meaning: any PDCCH candidate monitored for the first DCI format is a PDCCH candidate corresponding to an CIF value of a serving cell comprised in the first cell set in the first search space set.

In one embodiment, the technical feature that “at least one indicator value associated with the first cell set is used to determine a PDCCH candidate monitored for the first DCI format from the first search space set” includes the following meaning: any PDCCH candidate monitored for the first DCI format is a PDCCH candidate corresponding to a CIF (Carrier Indicator Field) value of a serving cell in a serving cell set that contains all serving cells associated with the CIF and comprises the first cell set.

In one embodiment, the technical feature that “at least one indicator value associated with the first cell set is used to determine a PDCCH candidate monitored for the first DCI format from the first search space set” includes the following meaning: the first cell sets comprise X1 serving cells, where X1 is a positive integer greater than 1; X1 indicator values are respectively associated with the X1 serving cells, and the X1 indicator values are used to respectively determine X1 candidate subsets from the first search space set, and any of the X1 candidate subsets comprises at least one PDCCH candidate; a first candidate subset comprises a PDCCH candidate monitored for the first DCI format in the first search space set, and the first candidate subset comprises at least one candidate subset in the X1 candidate subsets. In one subsidiary embodiment of the above embodiment, the first candidate subset comprises any of the X1 candidate subsets. In one subsidiary embodiment of the above embodiment, the first candidate subset comprises only one candidate subset in the X1 candidate subsets. In one subsidiary embodiment of the above embodiment, the first candidate subset is one of the X1 candidate subsets determined by a largest one of the X1 indicator values. In one subsidiary embodiment of the above embodiment, the first candidate subset is one of the X1 candidate subsets determined by a smallest one of the X1 indicator values. In one embodiment, the first candidate subset comprises a candidate subset associated with a serving cell in the first cell set among the X1 candidate subsets.

In one embodiment, the technical feature that “at least one indicator value associated with the first cell set is used to determine a PDCCH candidate monitored for the first DCI format from the first search space set” includes the following meaning: at least one indicator value associated with the first cell set is used to determine an index of a starting CCE occupied by a PDCCH candidate monitored for the first DCI format from the first search space set.

In one embodiment, the technical feature that “at least one indicator value associated with the first cell set is used to determine a PDCCH candidate monitored for the first DCI format from the first search space set” includes the following meaning: at least one indicator value associated with the first cell set is used to determine a distribution of PDCCH candidates monitored for the first DCI format in the first search space set.

In one embodiment, the expression in the claim that “at least one indicator value associated with the first cell set is used to determine a PDCCH candidate monitored for the first DCI format from the first search space set” is achieved by satisfying the following:
the first search space set s is associated with CORESET p, L denotes an aggregation level, n_{SI} denotes an indicator value, an index value, or an identity value configured to the first cell set, and an index of a CCE occupied by PDCCH candidate m_{s,n}_{_{SI}}^{(L)} monitored by the first DCI format in the first search space set satisfies

$$L \cdot \{ ( {Y}_{p , {n}_{s , f}^{μ}} + ⌊ \frac{{m}_{s , {n}_{SI}}^{( L )} \cdot {N}_{CCE , p}}{L \cdot {M}_{s , max}^{( L )}} ⌋ + {n}_{SI} ) mod ⌊ {N}_{CCE , p} / L ⌋ \} + i$$

herein, i=0, . . . , L−1, Y_{p,n}_{_{s,f}}_{^{μ}} is a value related to CORESET p, N_{CCE,p} denotes a number of CCE(s) in CORESET p, and M_{s,max}^{(L)} denotes a maximum number of PDCCH candidate(s) with aggregation level equal to L.

In one embodiment, the expression in the claim that “at least one indicator value associated with the first cell set is used to determine a PDCCH candidate monitored for the first DCI format from the first search space set” is achieved by satisfying the following:
the first search space set s is associated with CORESET p, L denotes an aggregation level, n_{SI_t} denotes an indicator value, an index value, or an identifier value configured by a serving cell comprised in the first cell set, and an index of a CCE occupied by PDCCH candidate msn monitored by the first DCI format in the first search space set satisfies

$$L \cdot \{ ( {Y}_{p , {n}_{s , f}^{μ}} + ⌊ \frac{{m}_{s , {n}_{{SI}_{t}}}^{( L )} \cdot {N}_{CCE , p}}{L \cdot {M}_{s , max}^{( L )}} ⌋ + {n}_{{SI}_{t}} ) mod ⌊ {N}_{CCE , p} / L ⌋ \} + i$$

herein, i=0, . . . , L−1, t=0, . . . , T−1, T denotes a number of serving cells comprised in the first cell set, Y_{p,n}_{_{s,f}}_{^{μ}} is a value related to CORESET p, N_{CCE,p} denotes a number of CCE(s) in CORESET p, and M_{s,max}^{(L)} denotes a maximum number of PDCCH candidate(s) with aggregation level equal to L.

In one embodiment, the expression in the claim that “at least one indicator value associated with the first cell set is used to determine a PDCCH candidate monitored for the first DCI format from the first search space set” is achieved by satisfying the following:
the first search space set s is associated with CORESET p, L denotes an aggregation level, n_{SI_t} denotes an indicator value, an index value, or an identifier value configured to a serving cell comprised in a feature cell set, and an index of a CCE occupied by PDCCH candidate m_{s,n}_{_{SI_t}}^{(L)} monitored by the first DCI format in the first search space set satisfies

$$L \cdot \{ ( {Y}_{p , {n}_{s , f}^{μ}} + ⌊ \frac{{m}_{s , {n}_{SI\_t}}^{( L )} \cdot {N}_{CCE , p}}{L \cdot {M}_{s , max}^{( L )}} ⌋ + {n}_{SI\_t} ) mod ⌊ {N}_{CCE , p} / L ⌋ \} + i$$

herein, i=0, . . . , L−1, t=0, . . . , T−1, T denotes a number of serving cells comprised in the feature cell set, the feature cell set is a set comprising serving cells associated with CIF in the first cell set, Y_{p,n}_{_{S,f}}_{^{μ}} is a value related to CORESET p, N_{CCE,p} denotes a number of CCE(s) in CORESET p, and M denotes a maximum number of PDCCH candidate(s) with aggregation level equal to L.

In one embodiment, the first quantity value is greater than 1.

In one embodiment, the first quantity value is not greater than the first threshold.

In one embodiment, the first quantity value is less than the first threshold.

In one embodiment, the first quantity value is not greater than a number of serving cell(s) scheduled by one DCI format or one PDCCH at the same time as indicated by a capability report of the first node.

In one embodiment, the technical feature that “a first quantity value is equal to a largest quantity value of numbers of serving cell(s) respectively comprised in the W1 cell sets” includes the following meaning: W1 quantity values are respectively equal to numbers of serving cell(s) respectively comprised in the W1 cell sets, and the first quantity value is equal to a largest one of the W1 quantity values.

In one embodiment, the technical feature that “a first quantity value is equal to a largest quantity value of numbers of serving cell(s) respectively comprised in the W1 cell sets” includes the following meaning: the first quantity value is equal to a number of serving cell(s) comprised in a cell set comprising most serving cell(s) in the W1 cell sets.

In one embodiment, a size of the first DCI format is equal to a payload size of the first DCI format.

In one embodiment, a size of the first DCI format is equal to a number of bit(s) comprised in the first DCI format.

In one embodiment, a size of the first DCI format is equal to a number of payload bit(s) comprised in the first DCI format.

In one embodiment, a size of the first DCI format is equal to a total number of bit(s) of payload bit(s) and CRC bit(s) comprised in the first DCI format.

In one embodiment, a size of the first DCI format is equal to a number of information bit(s) comprised in the first DCI format.

In one embodiment, a size of the first DCI format is equal to a total number of bit(s) of information bit(s) and CRC bit(s) comprised the first DCI format.

In one embodiment, a size of the first DCI format is equal to a size of the first DCI format not through size alignment.

In one embodiment, a size of the first DCI format is equal to a size of the first DCI format before size alignment of an uplink-scheduling DCI format and a downlink-scheduling DCI format.

In one embodiment, a size of the first DCI format is equal to a size of the first DCI format not through padding.

In one embodiment, a size of the first DCI format is equal to a size acquired after the first DCI format is through size alignment.

In one embodiment, a size of the first DCI format is equal to a size of the first DCI format after size alignment of an uplink-scheduling DCI format and a downlink-scheduling DCI format.

In one embodiment, a size of the first DCI format is equal to a size of the first DCI format through padding.

In one embodiment, a size of the first DCI format is an assumed size when monitoring a PDCCH candidate for the first DCI format.

In one embodiment, a size of the first DCI format is an assumed size when decoding a PDCCH assumed to carry the first DCI format.

In one embodiment, the technical feature that “a size of the first DCI format is related to the first quantity value” includes the following meaning: the first quantity value is used to determine a size of the first DCI format.

In one embodiment, the technical feature that “a size of the first DCI format is related to the first quantity value” includes the following meaning: a number of bit(s) comprised in at least one field in the first DCI format is related to the first quantity value.

In one embodiment, the technical feature that “a size of the first DCI format is related to the first quantity value” includes the following meaning: at least one of a number of bit(s) comprised in at least one field in the first DCI format or a number of field(s) with a same type comprised in the first DCI format is related to the first quantity value.

In one embodiment, the technical feature that “a size of the first DCI format is related to the first quantity value” includes the following meaning: a bit width of at least one field comprised in the first DCI format is related to the first quantity value.

In one embodiment, the technical feature that “a size of the first DCI format is related to the first quantity value” includes the following meaning: at least one of a number of bit(s) comprised in at least one field in the first DCI format or a number of field(s) comprised in the first DCI format is linearly related to the first quantity value.

In one embodiment, the technical feature that “a size of the first DCI format is related to the first quantity value” includes the following meaning: the first quantity value is used to determine at least one of a number of bit(s) comprised in at least one field in the first DCI format or a number of field(s) comprised in the first DCI format according to a condition relation or mapping rule.

In one embodiment, the technical feature that “a size of the first DCI format is related to the first quantity value” includes the following meaning: the first quantity value is used to calculate at least one of a number of bit(s) comprised in at least one field in the first DCI format or a number of field(s) comprised in the first DCI format.

In one embodiment, the technical feature that “a size of the first DCI format is related to the first quantity value” includes the following meaning: a number of bit(s) comprised in at least one field in the first DCI format is linearly correlated with an upward-rounding value of a logarithm value of the first quantity value with base 2.

In one embodiment, the technical feature that “a size of the first DCI format is related to the first quantity value” includes the following meaning: a number of field(s) comprised in the first DCI format is linearly correlated with an upward-rounding value of a logarithm value of the first quantity value with base 2.

In one embodiment, the technical feature that “a size of the first DCI format is related to the first quantity value” includes the following meaning: a number of bit(s) comprised in at least one field comprised in the first DCI format is linearly correlated with an upward-rounding value of a logarithm value of the first quantity value with base 2, and a number of field(s) comprised in the first DCI format is linearly correlated with the first quantity value.

In one embodiment, the technical feature that “a size of the first DCI format is related to the first quantity value” includes the following meaning: the first information block is used to determine W2 cell sets, and any of the W2 cell sets comprises at least one serving cell, W2 being a positive integer greater than 1; a second quantity value is equal to a largest number among numbers of serving cell(s) respectively comprised in the W2 cell sets, the second quantity value being a positive integer; the first quantity value is used to determine a first candidate size, the second quantity value is used to determine a second candidate size, and a size of the first DCI format is equal to a larger one of the first candidate size and the second candidate size.

In one embodiment, the technical feature that “a size of the first DCI format is related to the first quantity value” includes the following meaning: a size of the first DCI format is equal to a larger one of a first candidate size or a second candidate size, and the first quantity value is used to determine one of a first candidate size or a second candidate size.

In one embodiment, a number of bit(s) comprised in a field in the first DCI format is equal to a bit width of the field.

In one embodiment, at least one of a number of bit(s) comprised in an NDI (New Data Indictor) field, a number of bit(s) comprised in a HARQ process number field, and a number of bit(s) comprised in an MCS field in the first DCI format is related to the first quantity value.

In one embodiment, a number of bit(s) comprised in at least one field in a frequency-domain resource assignment field, a time-domain resource assignment field, a Physical Uplink Control Channel (PUCCH) resource indication field, a PDSCH to HARQ feedback timing indication field, an antenna port field, or a TCI (transmission configuration indication) field comprised in the first DCI format is related to the first quantity value.

In one embodiment, a total number of fields comprised in the first DCI format is related to the first quantity value.

In one embodiment, a total number of fields comprised in the first DCI format is linearly correlated with the first quantity value.

In one embodiment, a total number of field(s) of a same type comprised in the first DCI format is related to the first quantity value, the same type refers to one or more combinations of an NDI, a HARQ process number, an RV, an MCS, a frequency-domain resource assignment, a time-domain resource assignment, a PUCCH resource indication, a PDSCH to HARQ feedback timing indication, an antenna port, and a TCI.

In one embodiment, there exist several cell sets conforming to a nested structure among the W1 cell sets.

In one embodiment, any one of the multiple PDCCH candidates belongs to a first time window in time domain, and a subcarrier spacing of a subcarrier occupied by one of the multiple PDCCH candidates in frequency domain is equal to a first subcarrier spacing; a number of PDCCH candidate(s) adopting the first subcarrier spacing monitored within the first time window is not greater than a first threshold, and a number of non-overlapping CCE(s) adopting the first subcarrier spacing monitored within the first time window is not greater than a second threshold, the first threshold being a positive integer, the second threshold being a positive integer; both the first threshold and the second threshold are related to a feature proportion value, and a number of serving cell(s) in which the first cell set is counted is used to determine the feature proportion value, and the feature proportion value is not less than 0. In one subsidiary embodiment of the above embodiment, a number of serving cell(s) in which the first cell set is counted is equal to a number of serving cell(s) comprised in the first cell set. In one subsidiary embodiment of the above embodiment, a number of serving cell(s) in which the first cell set is counted is equal to 1. In one subsidiary embodiment of the above embodiment, all serving cells comprised in the first cell set are virtualized into (or equivalent to) N1 serving cell(s), where N1 can be an integer or a non-integer, and N1 is not less than 0. In one subsidiary embodiment of the above embodiment, the feature proportion value is equal to a ratio of a sum of serving cell(s) in which all serving cell(s) scheduled by a scheduling cell adopting the first subcarrier spacing is (are) counted (virtually or equivalently) comprised in the target cell set in the present application to a basic quantity, and the basic quantity is equal to a total number of serving cell(s) in which all serving cell(s) comprised in the target cell set is (are) counted (virtually or equivalently). In one subsidiary embodiment of the above embodiment, a cell group to which the first cell set belongs comprises M1 cell set(s), where M1 quantity value(s) is (are respectively) a number of serving cell(s) in which the M1 cell set(s) is (are respectively) counted, and the first cell set is one of the M1 cell set(s); a number of serving cells in which the first cell set is counted is equal to one of the M1 quantity value(s); any of the M1 quantity value(s) is not less than 0, and one of the M1 quantity value(s) can be an integer or a non-integer, M1 being a positive integer; the M1 cell set(s) comprises (comprise) M2 cell set(s), M2 being a positive integer not greater than M1, any serving cell comprised in any of the M2 cell set(s) is scheduled by a scheduling cell adopting the first subcarrier spacing; the feature proportion value is equal to a ratio of a sum of M2 quantity value(s) and a sum of M1 quantity value(s).

### Embodiment 2

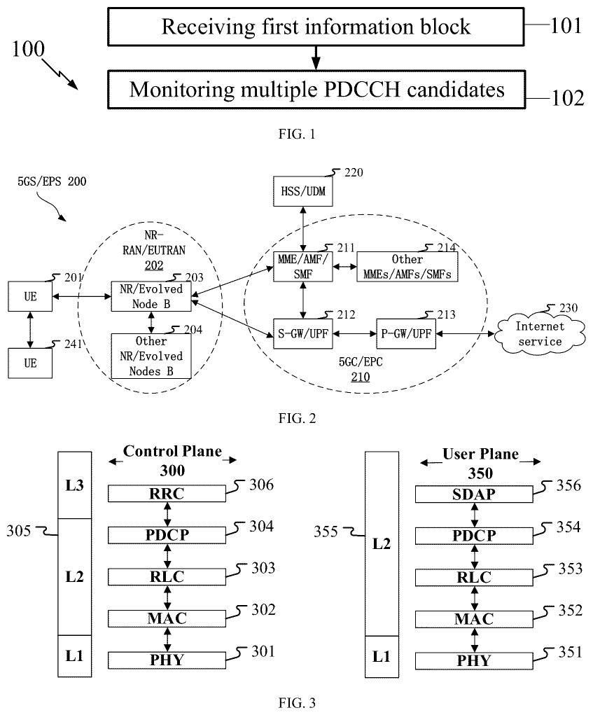

Embodiment 2 illustrates a schematic diagram of a network architecture according to the present application, as shown in FIG. 2. FIG. 2 illustrates a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN comprises an NR/evolved node B (gNB/eNB) 203 and other gNBs (eNBs) 204. The gNB (eNB) 203 provides UE 201-oriented user plane and control plane protocol terminations. The gNB (eNB) 203 may be connected to other gNBs (eNBs) 204 via an Xn/X2 interface (e.g., backhaul). The gNB (eNB) 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB (eNB) 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB (eNB) 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the gNB (eNB) 201 corresponds to the second node in the present application.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first node (UE or gNB) and a second node (gNB or UE) is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the first node and the second node via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second node and a first node. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

### Embodiment 4

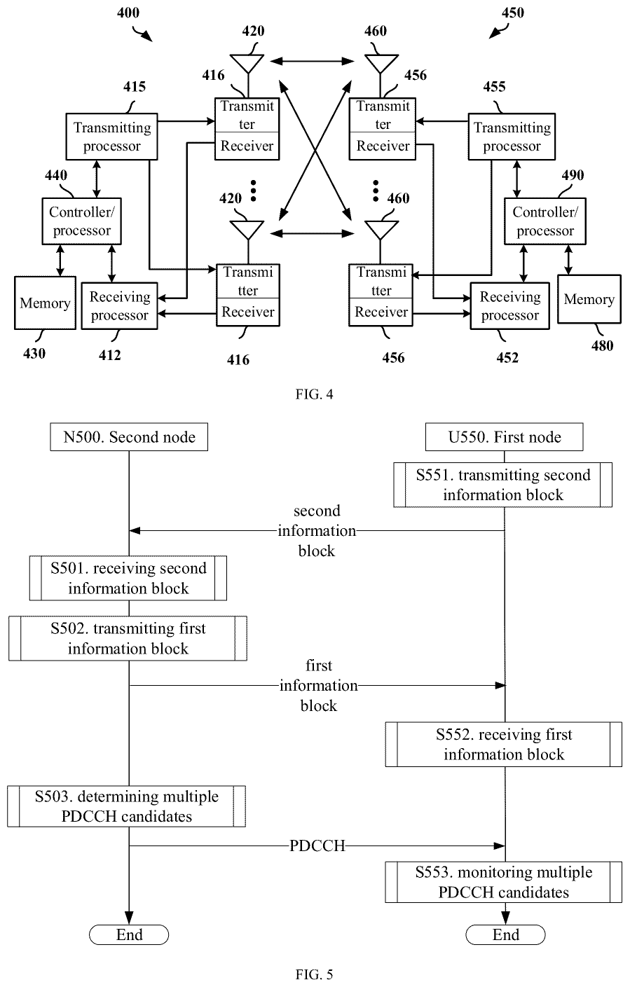

Embodiment 4 illustrates a schematic diagram of a first node and a second node according to one embodiment of the present application, as shown in FIG. 4.

The first node (450) may comprise a controller/processor 490, a data source/buffer 480, a receiving processor 452, a transmitter/receiver 456 and a transmitting processor 455, wherein the transmitter/receiver 456 comprises an antenna 460.

The second node (410) may comprise a controller/processor 440, a data source/buffer 430, a receiving processor 412, a transmitter/receiver 416 and a transmitting processor 415, wherein the transmitter/receiver 416 comprises an antenna 420.

In Downlink (DL) transmission, a higher layer packet (for example, higher layer information comprised in the first information block in the present application) is provided to the controller/processor 440. The controller/processor 440 implements the functionality of the L2 layer and the higher layer. In DL transmission, the controller/processor 440 provides header compression, encryption, packet segmentation and reordering and multiplexing between a logical channel and a transport channel, as well as radio resource allocation for the first node 450 based on varied priorities. The controller/processor 440 is also in charge of HARQ operation, retransmission of a lost packet, and a signaling to the first node 450, for instance, higher-layer information comprised in the first information block in the present application are all generated in the controller/processor 440. The transmitting processor 415 provides various signal processing functions for the L1 layer (that is, PHY), including coding, interleaving, scrambling, modulating, power control/allocation, precoding and generation of physical-layer control signaling, such as the generation of the physical-layer signal of the first information block in the present application and the physical-layer signal corresponding to the PDCCH candidate is completed at the transmitting processor 415. The generated modulation symbols are divided into parallel streams and each stream is mapped onto a corresponding multicarrier subcarrier and/or a multicarrier symbol, which is later mapped from the transmitting processor 415 to the antenna 420 via the transmitter 416 in the form of a radio frequency signal. At the receiving side, each receiver 456 receives an RF signal via a corresponding antenna 460, each receiver 456 recovers baseband information modulated to the RF carrier and provides the baseband information to the receiving processor 452. The receiving processor 452 provides various signal receiving functions for the L1 layer. The signal receiving and processing function includes monitoring a physical-layer signal of the first information block and a PDCCH candidate in the present application, demodulating based on various modulation schemes (e.g., BPSK, and QPSK) via a multicarrier symbol in a multicarrier symbol stream, followed by descrambling, decoding and de-interleaving to recover data or a control signal transmitted by the second node 410 on a physical channel, and then providing the data and the control signal to the controller/processor 490. The controller/processor 490 is in charge of the function of L2 layer and above layers, and the controller/processor 490 interprets higher layer information comprised in the first information block in the present application. The controller/processor can be connected to a memory 480 that stores program code and data. The memory 480 may be called a computer readable medium.

In uplink (UL) transmission, similar to downlink transmission, the higher-layer information, including higher-layer information comprised in the second information block in the present application, is generated by the controller/processor 490 and implemented by the transmitting processor 455 for various signal transmitting and processing functions at the L1 layer (i.e., physical layer), including the generation of the physical-layer signal carrying the second information block, which is completed at the transmitting processor 455 and then mapped to the antenna 460 by the transmitting processor 455 via the transmitter 456 to be transmitted in the form of an RF signal. The receiver 416 receives a radio-frequency signal via its corresponding antenna 420, and each receiver 416 recovers baseband information modulated to a radio-frequency carrier, and supplies the baseband information to the receiving processor 412. The receiving processor 412 implements various signal reception and processing functions for the L1 layer (i.e., the physical layer), including receiving and processing a physical-layer signal carrying a second information block, and then providing data and/or control signals to the controller/processor 440. The implementation of L2 layer functionality in the controller/processor 440 includes interpreting higher-layer information, including the interpretation of higher-layer information carried by the second information block. The controller/processor can be connected to a buffer 430 that stores program code and data. The buffer 430 may be called a computer readable medium.

In one embodiment, the first node 450 comprises at least one processor and at least one memory. The at least one memory comprises computer program codes; the at least one memory and the computer program codes are configured to be used in collaboration with the at least one processor. The first node 450 at least: receives a first information block, the first information block is used to determine W1 cell sets, any one of the W1 cell sets comprises at least one serving cell, W1 being a positive integer greater than 1; monitors multiple PDCCH candidates; herein, a number of serving cell(s) comprised in any one of the W1 cell sets is not greater than a first threshold, and the first threshold is a predefined or configurable positive integer; the multiple PDCCH candidates comprise at least one PDCCH candidate being monitored for a first DCI format, a first cell set is one of the W1 cell sets, and the first DCI format is used to schedule at least one serving cell comprised in the first cell set simultaneously; at least one of the multiple PDCCH candidates belongs to a first search space set, and at least one indicator value associated with the first cell set is used to determine a PDCCH candidate monitored for the first DCI format from the first search space set; a first quantity value is equal to a largest number among numbers of serving cell(s) respectively comprised in the W1 cell sets, and a size of the first DCI format is related to the first quantity value, the first quantity value being a positive integer.

In one embodiment, the first node 450 comprises a memory that stores a computer readable instruction program. The computer readable instruction program generates an action when executed by at least one processor. The action includes: receiving a first information block, the first information block being used to determine W1 cell sets, any one of the W1 cell sets comprising at least one serving cell, W1 being a positive integer greater than 1; monitoring multiple PDCCH candidates; herein, a number of serving cell(s) comprised in any one of the W1 cell sets is not greater than a first threshold, and the first threshold is a predefined or configurable positive integer; the multiple PDCCH candidates comprise at least one PDCCH candidate being monitored for a first DCI format, a first cell set is one of the W1 cell sets, and the first DCI format is used to schedule at least one serving cell comprised in the first cell set simultaneously; at least one of the multiple PDCCH candidates belongs to a first search space set, and at least one indicator value associated with the first cell set is used to determine a PDCCH candidate monitored for the first DCI format from the first search space set; a first quantity value is equal to a largest number among numbers of serving cell(s) respectively comprised in the W1 cell sets, and a size of the first DCI format is related to the first quantity value, the first quantity value being a positive integer.

In one embodiment, the second node 410 comprises at least one processor and at least one memory. The at least one memory comprises computer program codes; the at least one memory and the computer program codes are configured to be used in collaboration with the at least one processor. The second node 410 at least: transmits a first information block, the first information block is used to determine W1 cell sets, any one of the W1 cell sets comprises at least one serving cell, W1 being a positive integer greater than 1; determines multiple PDCCH candidates; herein, a number of serving cell(s) comprised in any one of the W1 cell sets is not greater than a first threshold, and the first threshold is a predefined or configurable positive integer; the multiple PDCCH candidates comprise at least one PDCCH candidate being monitored for a first DCI format, a first cell set is one of the W1 cell sets, and the first DCI format is used to schedule at least one serving cell comprised in the first cell set simultaneously; at least one of the multiple PDCCH candidates belongs to a first search space set, and at least one indicator value associated with the first cell set is used to determine a PDCCH candidate monitored for the first DCI format from the first search space set; a first quantity value is equal to a largest number among numbers of serving cell(s) respectively comprised in the W1 cell sets, and a size of the first DCI format is related to the first quantity value, the first quantity value being a positive integer.

In one embodiment, the second node device 410 comprises: a memory that stores a computer readable instruction program. The computer readable instruction program generates an action when executed by at least one processor. The action includes: transmitting a first information block, the first information block being used to determine W1 cell sets, any one of the W1 cell sets comprising at least one serving cell, W1 being a positive integer greater than 1; determining multiple PDCCH candidates; herein, a number of serving cell(s) comprised in any one of the W1 cell sets is not greater than a first threshold, and the first threshold is a predefined or configurable positive integer; the multiple PDCCH candidates comprise at least one PDCCH candidate being monitored for a first DCI format, a first cell set is one of the W1 cell sets, and the first DCI format is used to schedule at least one serving cell comprised in the first cell set simultaneously; at least one of the multiple PDCCH candidates belongs to a first search space set, and at least one indicator value associated with the first cell set is used to determine a PDCCH candidate monitored for the first DCI format from the first search space set; a first quantity value is equal to a largest number among numbers of serving cell(s) respectively comprised in the W1 cell sets, and a size of the first DCI format is related to the first quantity value, the first quantity value being a positive integer.

In one embodiment, the first node 450 is a UE.

In one embodiment, the second node 410 is a base station (gNB/eNB).

In one embodiment, the receiver 456 (including the antenna 460), the receiving processor 452 and the controller/processor 490 are used to receive the first information block in the present application.

In one embodiment, the receiver 456 (including the antenna 460), the receiving processor 452 and the controller/processor 490 are used to monitor a PDCCH candidate in the present application.

In one embodiment, the transmitter 456 (including the antenna 460), the transmitting processor 455 and the controller/processor 490 are used to transmit the second information block in the present application.

In one embodiment, the transmitter 416 (including the antenna 420), the transmitting processor 415 and the controller/processor 440 are used to transmit the first information block in the present application.

In one embodiment, the transmitter 416 (including the antenna 420), the transmitting processor 415 and the controller/processor 440 are used to determine a PDCCH candidate in the present application.

In one embodiment, the receiver 416 (including the antenna 420), the receiving processor 412 and the controller/processor 440 are used to receive the second information block in the present application.

### Embodiment 5

Embodiment 5 illustrates a flowchart of radio signal transmission according to one embodiment in the present application, as shown in FIG. 5. In FIG. 5, a second node N500 is a maintenance base station of a serving cell of a first node U550. It is particularly underlined that the order illustrated in the embodiment does not put constraints over sequences of signal transmissions and implementations.

The second node N500 receives a second information block in step S501, transmits a first information block in step S502, and determines multiple PDCCH candidates in step S503.

The first node U550 transmits a second information block in step S551, receives a first information block in step S552, and monitors multiple PDCCH candidates in step S553.

In embodiment 5, the first information block is used to determine W1 cell sets, and any one of the W1 cell sets comprises at least one serving cell, W1 being a positive integer greater than 1; a number of serving cell(s) comprised in any one of the W1 cell sets is not greater than a first threshold, and the first threshold is a predefined or configurable positive integer; the multiple PDCCH candidates comprise at least one PDCCH candidate being monitored for a first DCI format, a first cell set is one of the W1 cell sets, and the first DCI format is used to schedule at least one serving cell comprised in the first cell set simultaneously; at least one of the multiple PDCCH candidates belongs to a first search space set, and at least one indicator value associated with the first cell set is used to determine a PDCCH candidate monitored for the first DCI format from the first search space set; a first quantity value is equal to a largest number among numbers of serving cell(s) respectively comprised in the W1 cell sets, and a size of the first DCI format is related to the first quantity value, the first quantity value being a positive integer; the second information block is used to indicate a capability parameter set of a transmitter of the second information block, and the capability parameter set of the transmitter of the second information block comprises at least a first parameter and a second parameter; the first parameter is used to indicate a number of downlink serving cell(s) that is supported by the transmitter of the second information block to be scheduled by one PDCCH simultaneously, and the second parameter is used to indicate a number of uplink serving cell(s) that is supported by the transmitter of the second information block to be scheduled by one PDCCH simultaneously.

In one embodiment, the second information is transmitted via an air interface or a radio interface.

In one embodiment, the second information block comprises all or part of a higher-layer signaling or physical-layer signaling.

In one embodiment, the second information block is earlier than the first information block.

In one embodiment, the second information block is earlier than the first information block.

In one embodiment, the second information block comprises all or part of an RRC signaling, or the second information block comprises all or part of a MAC layer signaling.

In one embodiment, the second information block is transmitted through a PUSCH or a PUCCH (Physical Uplink Control Channel).

In one embodiment, the second information block is used for indicating a capability of the first node in the present application.

In one embodiment, the technical feature that “the second information block is used to indicate a capability parameter set of a transmitter of the second information block” includes the following meaning: the second information block is used by the first node in the present application to indicate a capability parameter set of the first node.

In one embodiment, the technical feature that “the second information block is used to indicate a capability parameter set of a transmitter of the second information block” includes the following meaning: all or part of the second information block is used to explicitly or implicitly indicate a capability parameter set for a transmitter of the second information block.

In one embodiment, the second information block comprises IE “Phy-ParametersFRX-Diff”, or the second information block comprises IE “UE-NR-Capability”.

In one embodiment, the second information block comprises field “pdcch-MonitoringCA”, or the second information block comprises field “pdcch-BlindDetectionCA”, or the second information block comprises field “CA-ParametersNR”, or the second information block comprises field “searchSpaceSharingCA-DL”, or the second information block comprises field “searchSpaceSharingCA-UL”, or the second information block comprises field “SingleDCIMultipleCell-DL”, or the second information block comprises field “SingleDCIMultipleCel-UL”, or the second information block comprises field “SingleDCIMultipleCellsearchSpaceSharingCA-DL”, or the second information block comprises field “SingleDCIMultipleCellsearchSpaceSharingCA-UL”, or the second information block comprises field “Phy-Parameters”.

### Embodiment 6

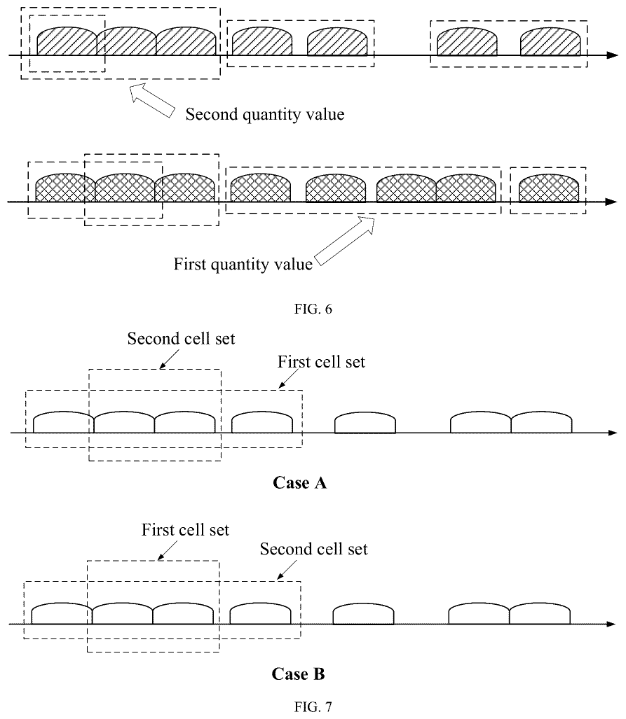

Embodiment 6 illustrates a schematic diagram of a first quantity value and a second quantity value according to one embodiment of the present application, as shown in FIG. 6. In FIG. 6, each cross-line-filled arc-top region represents a serving cell comprised in one of W1 cell sets, and each slash-filled arc-top region represents a serving cell comprised in one of W2 cell sets; cross-line filled serving cells in each dotted box consist one of W1 cell sets, and slash-filled serving cells in each dotted box consist one of W2 cell sets; a first quantity value is equal to a number of serving cell(s) in a cell set comprising a most serving cell(s) in W1 cell sets, and a second quantity value is equal to a number of serving cell(s) in a cell set comprising a most serving cell(s) in W2 cell sets.

In Embodiment 6, the first information block in the present application is used to determine W2 cell sets, and any one of the W2 cell sets comprises at least one serving cell, W2 being a positive integer greater than 1; a second quantity value is equal to a largest number among numbers of serving cell(s) respectively comprised in the W2 cell sets, the second quantity value being a positive integer; the first quantity value in the present application is used to determine a first candidate size, the second quantity value is used to determine a second candidate size, and a size of the first DCI format in the present application is equal to a larger one of the first candidate size and the second candidate size.

In one embodiment, the technical feature that “the first information block is used to determine the W2 cell sets” includes the following meaning: part or all of the first information block is used to explicitly or implicitly indicate the W2 cell sets.

In one embodiment, the technical feature that “the first information block is used to determine the W2 cell sets” includes the following meaning: part or all of the first information block is used to explicitly or implicitly indicate a list composed of W2 cell sets.

In one embodiment, the technical feature that “the first information block is used to determine the W2 cell sets” includes the following meaning: part or all of the first information block is used to explicitly or implicitly indicate serving cell(s) comprised in W2 cell sets.

In one embodiment, the technical feature that “the first information block is used to determine the W2 cell sets” includes the following meaning: part or all of the first information block is used to explicitly or implicitly add the W2 cell sets into a list.

In one embodiment, the technical feature that “the first information block is used to determine the W2 cell sets” includes the following meaning: part or all of the first information block is used to explicitly or implicitly release a cell set to obtain a list consisting of W2 cell sets.

In one embodiment, the technical feature that “the first information block is used to determine the W2 cell sets” includes the following meaning: part or all of the first information block is used to explicitly or implicitly add serving cell(s) to consist one of the W2 cell sets.

In one embodiment, the technical feature that “the first information block is used to determine the W2 cell sets” includes the following meaning: part or all of the first information block is used to explicitly or implicitly release a serving cell to obtain one of the W2 cell sets.

In one embodiment, the technical feature that “the first information block is used to determine the W2 cell sets” includes the following meaning: part or all of the first information block is used to explicitly or implicitly indicate a number of serving cell(s) comprised in at least one of the W2 cell sets.

In one embodiment, the technical feature that “the first information block is used to determine the W2 cell sets” includes the following meaning: part or all of the first information block is used to explicitly or implicitly indicate an upper limit of a number of serving cell(s) comprised in at least one of the W2 cell sets.

In one embodiment, the technical feature that “the first information block is used to determine the W2 cell sets” includes the following meaning: the first information block is used to determine the W1 cell sets, and the W1 cell sets are used to determine the W2 cell sets.

In one embodiment, the technical feature that “the first information block is used to determine the W2 cell sets” includes the following meaning: W2 is equal to W1, and the W2 cell sets correspond one-to-one with the W1 cell sets, any one of the W2 cell sets belongs to a corresponding cell set in the W1 cell sets, and the first information block is used to determine a corresponding cell set in the W2 cell sets from any one of the W1 cell sets.

In one embodiment, the technical feature that “the first information block is used to determine the W2 cell sets” includes the following meaning: W2 is equal to the W1, and the W2 cell sets correspond one-to-one with the W1 cell sets, the first information block is used to determine a non-overlapping serving cell between any one of the W1 cell sets and a corresponding cell set in the W2 cell sets.

In one embodiment, two different fields comprised in the first information block or two different sub-fields within a same field are used to determine the W1 cell sets and the W2 cell sets, respectively.

In one embodiment, two different IEs are respectively used to determine the W1 cell sets and the W2 cell sets.

In one embodiment, the W2 cell sets consist of a cell set list.

In one embodiment, any serving cell comprised in any one of the W2 cell sets is a serving cell that can transmit a PDSCH.

In one embodiment, any serving cell comprised in any one of the W2 cell sets is a serving cell that can transmit a PUSCH.

In one embodiment, any two of the W2 cell sets are different.

In one embodiment, there exist two of the W2 cell sets being the same.

In one embodiment, any one of the W2 cell sets is a set of serving cell(s) that can be scheduled by one DCI format or one PDCCH at the same time.

In one embodiment, any one of the W2 cell sets is a set of serving cell(s) to which PDSCH(s) that can be scheduled by one DCI format or one PDCCH at the same time belongs (respectively belong).

In one embodiment, any one of the W2 cell sets is a set of serving cell(s) to which PUSCH(s) that can be scheduled by one DCI format or one PDCCH at the same time belongs (respectively belong).

In one embodiment, any one of the W1 cell sets is a set of serving cell(s) to which PDSCH(s) that can be scheduled by one DCI format or one PDCCH at the same time belongs (respectively belong), and any one of the W2 cell sets is a set of serving cell(s) to which PUSCH(s) that can be scheduled by one DCI format or one PDCCH at the same time belongs (respectively belong).

In one embodiment, any one of the W1 cell sets is a set of serving cell(s) to which PUSCH(s) that can be scheduled by one DCI format or one PDCCH at the same time belongs (respectively belong), and any one of the W2 cell sets is a set of serving cell(s) to which PDSCH(s) that can be scheduled by one DCI format or one PDCCH at the same time belongs (respectively belong).

In one embodiment, any one of the W2 cell sets is a list of serving cells.

In one embodiment, all serving cells comprised in one of the W2 cell sets belong to a same frequency band.

In one embodiment, all serving cells comprised in one of the W2 cell sets belong to a same frequency range (FR).

In one embodiment, all serving cells comprised in one of the W2 cell sets adopt a same duplex mode (TDD, Time Division Duplexing or FDD, Frequency Division Duplexing).

In one embodiment, one of the W2 cell sets comprises two intra-band serving cells.

In one embodiment, one of the W2 cell sets comprises two inter-band serving cells.

In one embodiment, one of the W2 cell sets comprises two serving cells respectively belonging to two different frequency bands.

In one embodiment, two serving cells comprised in one of the W2 cell sets respectively belong to two different frequency ranges.

In one embodiment, two serving cells comprised in one of the W2 cell sets respectively adopt different duplex modes (TDD or FDD).

In one embodiment, all serving cells outside a self-scheduling cell comprised in any one of the W2 cell sets belong to a same frequency band.

In one embodiment, all serving cells outside a self-scheduling cell comprised in any one of the W2 cell sets belong to a same frequency range.

In one embodiment, all serving cells outside a self-scheduling cell comprised in any one of the W2 cell sets adopt a same duplex mode (TDD or FDD).

In one embodiment, any one of the W2 cell sets comprises multiple serving cells.

In one embodiment, there exists at least one of the W2 cell sets only comprising one serving cell.

In one embodiment, a number of serving cell(s) comprised in any one of the W2 cell sets is not greater than a number of serving cell(s) comprising PDSCH(s) scheduled by a DCI format or a PDCCH at the same time and supported by a capability of the first node.

In one embodiment, a number of serving cell(s) comprised in any of the W2 cell sets is not greater than a number of serving cell(s) comprising PUSCHs scheduled by a DCI format or a PDCCH at the same time and supported by a capability of the first node.

In one embodiment, a number of serving cell(s) comprised in any of the W2 cell sets is not greater than a number of serving cell(s) scheduled by a DCI format or a PDCCH at the same time and supported by a capability of the first node.

In one embodiment, a number of serving cell(s) comprised in any one of the W1 cell sets is not greater than a second threshold, and the second threshold is predefined or configurable. In one subsidiary embodiment of the above embodiment, the second threshold is equal to the first threshold. In one subsidiary embodiment of the above embodiment, the second threshold is less than the first threshold. In one subsidiary embodiment of the above embodiment, the second threshold is greater than the first threshold. In one subsidiary embodiment of the above embodiment, the second threshold is equal to 8. In one subsidiary embodiment of the above embodiment, the second threshold is equal to 4. In one subsidiary embodiment of the above embodiment, the second threshold is equal to 3.

In one embodiment, W2 is equal to W1.

In one embodiment, W2 is not equal to W1.

In one embodiment, the W1 cell sets and the W2 cell sets are respectively and independently configured.

In one embodiment, the W2 cell sets are configured based on the W1 cell sets.

In one embodiment, W2 is equal to W1, and the W2 cell sets correspond one-to-one with the W1 cell sets, and any one of the W2 cell sets belongs to a corresponding cell set in the W1 cell sets.

In one embodiment, W2 is equal to W1, and the W2 cell sets correspond one-to-one with the W1 cell sets, and any one of the W1 cell sets belongs to a corresponding cell set in the W2 cell sets.

In one embodiment, W2 is equal to W1, and the W2 cell sets correspond one-to-one with the W1 cell sets, any one of the W2 cell sets belongs to a corresponding cell set in the W1 cell sets, the first information block is used to determine a corresponding cell set in the W2 cell sets from any one of the W1 cell sets.

In one embodiment, W2 is equal to the W1, and the W2 cell sets correspond one-to-one with the W1 cell sets, the first information block is used to determine a non-overlapping serving cell between any one of the W1 cell sets and a corresponding cell set in the W2 cell sets.

In one embodiment, one of the W2 cell sets comprises all serving cells comprised in any one of the other two cell sets in the W2 cell sets.

In one embodiment, there exist several cell sets in the W2 cell sets conforming to a nested structure.

In one embodiment, the second quantity value is greater than 1.

In one embodiment, the second quantity value is not greater than a first threshold.

In one embodiment, the second quantity value is less than a first threshold.

In one embodiment, the second quantity value is not greater than a number of serving cell(s) scheduled by a DCI format or a PDCCH at the same time as indicated by a capability report of the first node.

In one embodiment, the technical feature that “a second quantity value is equal to a maximum number of serving cell(s) comprised in the W2 cell sets” includes the following meaning: W2 quantity values are equal to numbers of serving cell(s) respectively comprised in the W2 cell sets, and the second quantity value is equal to a largest quantity value in the W2 quantity values.

In one embodiment, the technical feature that “a second quantity value is equal to a largest quantity value in numbers of serving cell(s) respectively comprised in the W2 cell sets” includes the following meaning: the second quantity value is equal to a number of serving cell(s) comprised in a cell set comprising most serving cell(s) in the W2 cell sets.

In one embodiment, the first candidate size is equal to a size of a DCI format for scheduling a PUSCH.

In one embodiment, the second candidate size is equal to a size of a DCI format for scheduling a PDSCH.

In one embodiment, the first candidate size is equal to a size of a DCI format for scheduling a PDSCH.

In one embodiment, the second candidate size is equal to a size of a DCI format for scheduling a PUSCH.

In one embodiment, the first candidate size is equal to a size of a DCI format for scheduling a PUSCH before size alignment.

In one embodiment, the second candidate size is equal to a size of a DCI format for scheduling a PDSCH before size alignment.

In one embodiment, the first candidate size is equal to a size of a DCI format for scheduling a PDSCH before size alignment.

In one embodiment, the second candidate size is equal to a size of a DCI format for scheduling a PUSCH before size alignment.

In one embodiment, the first candidate size is equal to a size of a DCI format before size alignment.

In one embodiment, the first candidate size is equal to a size of a DCI format before one or more fields in a DCI format are not padded.

In one embodiment, the first candidate size is equal to a size of a DCI format.

In one embodiment, the second candidate size is equal to a size of a DCI format before size alignment.

In one embodiment, the second candidate size is equal to a size of a DCI format before one or more fields in a DCI format are not padded.

In one embodiment, the second candidate size is equal to a size of a DCI format.

In one embodiment, the first candidate size is equal to a size of DCI format 0_K before size alignment, and the second candidate size is equal to a size of DCI format 1_K before size alignment, where K is a positive integer greater than 2. In one subsidiary embodiment of the above embodiment, K is equal to 3. In one subsidiary embodiment of the above embodiment, K is equal to 4. In one subsidiary embodiment of the above embodiment, K is equal to 5.

In one embodiment, the first candidate size is equal to a size of DCI format 1_K before size alignment, and the second candidate size is equal to a size of DCI format 0_K before size alignment, where K is a positive integer greater than 2. In one subsidiary embodiment of the above embodiment, K is equal to 3. In one subsidiary embodiment of the above embodiment, K is equal to 4. In one subsidiary embodiment of the above embodiment, K is equal to 5.

In one embodiment, the first candidate size is equal to a positive integer, and the second candidate size is equal to a positive integer.

In one embodiment, the technical feature that “the first quantity value is used to determine a first candidate size” includes the following meaning: the first quantity value is used by the first node or the second node in the present application to determine the first candidate size.

In one embodiment, the technical feature that “the second quantity value is used to determine a second candidate size” includes the following meaning: the second quantity value is used by the first node or the second node in the present application to determine the second candidate size.

In one embodiment, the technical feature that “the first quantity value is used to determine a first candidate size” includes the following meaning: the first candidate size is linearly correlated with the first quantity value.

In one embodiment, the technical feature that “the second quantity value is used to determine a second candidate size” includes the following meaning: the second candidate size is linearly correlated with the second quantity value.

In one embodiment, the technical feature that “the first quantity value is used to determine a first candidate size” includes the following meaning: the first quantity value is used to determine a number of bit(s) comprised in at least one field comprised in a DCI format corresponding to the first candidate size; the technical feature that “the second quantity value is used to determine a second candidate size” includes the following meaning: the second quantity value is used to determine a number of bit(s) comprised in at least one field comprised in a DCI format corresponding to the second candidate size.

In one embodiment, the technical feature that “the first quantity value is used to determine a first candidate size” includes the following meaning: the first quantity value is used to determine at least one of a number of bit(s) comprised in at least one field comprised in a DCI format corresponding to the first candidate size or a number of field(s) of a same type comprised in a DCI format corresponding to the first candidate size; the technical feature that “the second quantity value is used to determine a second candidate size” includes the following meaning: the second quantity value is used to determine at least one of a number of bit(s) comprised in at least one field comprised in a DCI format corresponding to the second candidate size or a number of field(s) of a same type comprised in a DCI format corresponding to the second candidate size.

In one embodiment, the technical feature that “the first quantity value is used to determine a first candidate size” includes the following meaning: a number of bit(s) comprised in at least one field of a DCI format corresponding to the first candidate size is linearly correlated with an up-rounding value of a logarithm value of the first quantity value at the base of 2; the technical feature that “the second quantity value is used to determine a second candidate size” includes the following meaning: a number of bit(s) comprised in at least one field of a DCI format corresponding to the second candidate size is linearly correlated with an up-rounding value of a logarithm value of the second quantity value at the base of 2.

In one embodiment, the technical feature that “the first quantity value is used to determine a first candidate size” includes the following meaning: a number of field(s) comprised in a DCI format corresponding to the first candidate size is linearly correlated with the first quantity value; the technical feature that “the second quantity value is used to determine a second candidate size” includes the following meaning: a number of field(s) comprised in a DCI format corresponding to the second candidate size is linearly correlated with the second quantity value.

In one embodiment, the technical feature that “the first quantity value is used to determine a first candidate size” includes the following meaning: a number of field(s) with a same type comprised in a DCI format corresponding to the first candidate size is linearly correlated with the first quantity value; the technical feature that “the second quantity value is used to determine a second candidate size” includes the following meaning: a number of field(s) with a same type comprised in a DCI format corresponding to the second candidate size is linearly correlated with the second quantity value; the same type refers to one or more combinations of an NDI, a HARQ process number, an RV, an MCS, a frequency-domain resource allocation, a time-domain resource allocation, a PUCCH resource indication, a PDSCH to HARQ feedback timing indication, an antenna port, and a TCI.

In one embodiment, the technical feature that “the first quantity value is used to determine a first candidate size” includes the following meaning: a number of bit(s) comprised in at least one field of a DCI format corresponding to the first candidate size is linearly correlated with an up-rounding value of a logarithm value of the first quantity value at the base of 2, and a number of field(s) comprised in a DCI format corresponding to the first candidate size is linearly correlated with the first quantity value; the technical feature that “the second quantity value is used to determine a second candidate size” includes the following meaning: a number of bit(s) comprised in at least one field of a DCI format corresponding to the second candidate size is linearly correlated with an up-rounding value of a logarithm value of the second quantity value at the base of 2, and a number of field(s) comprised in a DCI format corresponding to the second candidate size is linearly correlated with the second quantity value.

In one embodiment, when the first candidate size is greater than the second candidate size, a size of the first DCI format is equal to the first candidate size; when the first candidate size is less than the second candidate size, a size of the first DCI format is equal to the second candidate size; when the first candidate size is equal to the second candidate size, a size of the first DCI format is equal to the first candidate size and the second candidate size.

In one embodiment, when the first candidate size is greater than the second candidate size, a DCI format corresponding to the second candidate size makes its own size equal to the first candidate size by size alignment; when the first candidate size is less than the second candidate size, a DCI format corresponding to the first candidate size makes its own size equal to the second candidate size by size alignment.

In one embodiment, when the first candidate size is greater than the second candidate size, a DCI format corresponding to the second candidate size makes its own size equal to the first candidate size by size alignment, and a DCI format corresponding to the first candidate size remains unchanged; when the first candidate size is less than the second candidate size, a DCI format corresponding to the first candidate size makes its own size equal to the second candidate size by size alignment, and a DCI format corresponding to the second candidate size remains unchanged; when the first candidate size is equal to the second candidate size, a DCI format corresponding to the first candidate size remains unchanged, and a DCI format corresponding to the second candidate size remains unchanged.

In one embodiment, when the first candidate size is greater than the second candidate size, a DCI format corresponding to the second candidate size makes its own size equal to the first candidate size through padding bits; when the first candidate size is less than the second candidate size, a DCI format corresponding to the first candidate size makes its own size equal to the second candidate size through padding bits.

### Embodiment 7

Embodiment 7 illustrates a schematic diagram of a relation between a first cell set and a second cell set according to one embodiment of the present application, as shown in FIG. 7. In FIG. 7, each arc-top region represents a serving cell, and serving cells circled by dotted lines constitute a first cell set or a second cell set; in case A, a first cell set comprises a second cell set; in case B, a second cell set comprises a first cell set.

In embodiment 7, a second DCI format is a DCI format different from the first DCI format in the present application, and the second DCI format and the first DCI format are respectively used for scheduling in different link directions; the second DCI format is used to schedule at least one serving cell in a second cell set, and the second cell set comprises multiple serving cells; when the first DCI format is used for downlink scheduling, the first cell set in the present application comprises the second cell set; when the first DCI format is used for uplink scheduling, the second cell set comprises the first cell set.

In one embodiment, a size of the first DCI format is equal to a size of the second DCI format.

In one embodiment, a size of the first DCI format is not equal to a size of the second DCI format.

In one embodiment, a size of the first DCI format before size alignment is not equal to a size of the second DCI format before size alignment.

In one embodiment, a size of the first DCI format before size alignment is equal to a size of the second DCI format before size alignment.

In one embodiment, a size of the first DCI format after size alignment is equal to a size of the second DCI format after size alignment.

In one embodiment, the first DCI format is DCI format 0_K, and the second DCI format is DCI format 1_K, where K is a positive integer greater than 2. In one subsidiary embodiment of the above embodiment, K is equal to 3. In one subsidiary embodiment of the above embodiment, K is equal to 4. In one subsidiary embodiment of the above embodiment, K is equal to 5.

In one embodiment, the first DCI format is DCI format 1_K, and the second DCI format is DCI format 0_K, where K is a positive integer greater than 2. In one subsidiary embodiment of the above embodiment, K is equal to 3. In one subsidiary embodiment of the above embodiment, K is equal to 4. In one subsidiary embodiment of the above embodiment, K is equal to 5.

In one embodiment, the first DCI format comprising a Flag bit is used to indicate a link direction of the first DCI format, and the second DCI format comprising a Flag bit is used to indicate a link direction of the second DCI format.

In one embodiment, the technical feature that “the second DCI format and the first DCI format are respectively used for scheduling in different link directions” includes the following meaning: the second DCI format and the first DCI format are respectively uplink and downlink DCI formats.

In one embodiment, the technical feature that “the second DCI format and the first DCI format are respectively used for scheduling in different link directions” includes the following meaning: the first DCI format is a DCI format for scheduling a downlink channel or signal, and the second DCI format is a DCI format for scheduling an uplink channel or signal; or the first DCI format is a DCI format for scheduling an uplink channel or signal, and the second DCI format is a DCI format for scheduling a downlink channel or signal.

In one embodiment, the technical feature that “the second DCI format and the first DCI format are respectively used for scheduling in different link directions” includes the following meaning: the first DCI format is a DCI format for scheduling a PDSCH, and the second DCI format is a DCI format for scheduling a PUSCH; or the first DCI format is a DCI format for scheduling a PUSCH, and the second DCI format is a DCI format for scheduling a PDSCH.

In one embodiment, the technical feature that “the second DCI format and the first DCI format are respectively used for scheduling in different link directions” includes the following meaning: the first DCI format is DCI format 0_K, and the second DCI format is DCI format 1_K; or the first DCI format is DCI format 1_K, and the second DCI format is DCI format 0_K; where K is equal to 3 or K is equal to 4 or K is equal to 5.

In one embodiment, the second DCI format is one of DCI formats supported by a UE-Specific Search Set (USS set).

In one embodiment, any serving cell scheduled by the second DCI format is a serving cell scheduled by a PDCCH carrying the second DCI format.

In one embodiment, any serving cell scheduled by the second DCI format is a serving cell to which at least one channel or signal scheduled by the first DCI format belongs.

In one embodiment, any serving cell scheduled by the second DCI format is a serving cell to which at least one shared channel scheduled by the second DCI format belongs.

In one embodiment, any serving cell scheduled by the second DCI format is configured as a serving cell scheduled by the second DCI format.

In one embodiment, any the serving cell scheduled by the second DCI format is a serving cell comprised by a downlink assignment or an uplink grant in the second DCI format.

In one embodiment, the second DCI format is used to indicate the second cell set.

In one embodiment, the second DCI format is used to indicate the second cell set from multiple cell sets.

In one embodiment, a number of serving cell(s) scheduled by the second DCI format at the same time is greater than 1.

In one embodiment, all serving cells comprised in the second cell set are configured to be scheduled by a same DCI format or by a same PDCCH.

In one embodiment, the second cell set is a one of the W1 cell sets.

In one embodiment, all serving cells comprised in the second cell set have a same numerology.

In one embodiment, all serving cells comprised in the second cell set have a same subcarrier spacing.

In one embodiment, all serving cells comprised in the second cell set have a CP length.

In one embodiment, all serving cells comprised in the second cell set have a same scheduling cell.

In one embodiment, the first cell set and the second cell set are respectively configured by two different fields in a signaling, or by two different IEs, or by two different signalings.

In one embodiment, at least one higher-layer signaling or higher-layer parameter is used to configure the second cell set.

In one embodiment, the second cell set comprises all serving cells identified by a same identity or a same index.

In one embodiment, the second cell set comprises all serving cell(s) that may be scheduled by one DCI format or one PDCCH at the same time and configured by higher-layer signalings or parameters.

In one embodiment, the second cell set comprises all serving cells that can be assumed to be scheduled by a DCI format or a PDCCH at the same time when adopting the second DCI format to monitor a PDCCH candidate.

In one embodiment, the second cell set comprises not less than 3 serving cells.

In one embodiment, the second cell set comprises not greater than 3 serving cells.

In one embodiment, an upper limit of a number of serving cell(s) comprised in the second cell set is equal to 4 or 8.

In one embodiment, any two serving cells comprised in the second cell set belong to a same PUCCH group.

In one embodiment, any two serving cells comprised in the second cell set belong to a same cell group.

In one embodiment, any two serving cells comprised in the second cell set belong to a same frequency range.

In one embodiment, any two serving cells comprised in the second cell set belong to a same band.

In one embodiment, the second cell set comprises two serving cells respectively belonging to two different frequency ranges.

In one embodiment, two serving cells comprised in the second cell set respectively belong to two different bands.

In one embodiment, any two serving cells comprised in the second cell set are Intra-band.

In one embodiment, the second cell set comprises two serving cells being Inter-band.

In one embodiment, the technical feature that “the second DCI format is used to schedule at least one serving cell in the second cell set” includes the following meaning: the second DCI format is used to schedule all serving cells comprised in the second cell set at the same time.

In one embodiment, the technical feature that “the second DCI format is used to schedule at least one serving cell in the second cell set” includes the following meaning: the second DCI format is configured by a higher-layer signaling or higher-layer parameter to schedule all serving cells comprised in the second cell set at the same time, and the second DCI format actually schedules all or part of serving cells comprised in the second cell set at the same time.

In one embodiment, the technical feature that “the second DCI format is used to schedule at least one serving cell in the second cell set” includes the following meaning: the second DCI format can at most schedule all serving cells comprised in the second cell set at the same time.

In one embodiment, the technical feature that “the second DCI format is used to schedule at least one serving cell in the second cell set” includes the following meaning: a downlink assignment or uplink grant of all serving cells comprised in the second cell set can be comprised in the second DCI format at the same time.

In one embodiment, the technical feature that “the second DCI format is used to schedule at least one serving cell in the second cell set” includes the following meaning: the second DCI format is configured by a higher-layer signaling or a higher-layer parameter to schedule all serving cells comprised in the second cell set at the same time, and all or part of the second DCI format is used explicitly or implicitly to indicate serving cells in the second cell set actually scheduled by the second DCI format at the same time.

In one embodiment, the technical feature that “the second DCI format is used to schedule at least one serving cell in the second cell set” includes the following meaning: the second DCI format is used to schedule multiple serving cells comprised in the second cell set, meaning that the second DCI format is used to schedule a PDSCH (Physical Downlink Shared Channel) or a PUSCH (Physical Uplink Shared Channel) respectively on the multiple serving cells at the same time; the second DCI format is used to schedule a serving cell comprised in the second cell set, meaning that the second DCI format is only used to schedule a PDSCH (Physical Downlink Shared Channel) or a PUSCH (Physical Uplink Shared Channel) on the serving cell.

In one embodiment, the technical feature that “the first cell set comprises the second cell set” includes the following meaning: the first cell set comprises any serving cell in the second cell set.

In one embodiment, the technical feature that “the first cell set comprises the second cell set” includes the following meaning: any serving cell in the second cell set belongs to the first cell set.

In one embodiment, the technical feature that “the first cell set comprises the second cell set” includes the following meaning: the first cell set is identical to the second cell set, or the first cell set comprises any serving cell in the second cell set and the first cell set also comprises at least one serving cell other than the second cell set.

In one embodiment, the technical feature that “the second cell set comprises the first cell set” includes the following meaning: the second cell set comprises any serving cell in the first cell set.

In one embodiment, the technical feature that “the second cell set comprises the first cell set” includes the following meaning: any serving cell in the first cell set belongs to the second cell set.

In one embodiment, the technical feature that “the second cell set comprises the first cell set” includes the following meaning: the first cell set is identical to the second cell set, or the second cell set comprises any serving cell in the first cell set and the second cell set also comprises at least one serving cell other than the first cell set.

In one embodiment, the statements that “the first DCI format is used for downlink scheduling” and “the first DCI format is used for scheduling a PDSCH” are equivalent or interchangeable.

In one embodiment, the statements that “the first DCI format is used for downlink scheduling” and “the first DCI format is used for scheduling a PDSCH and the second DCI format is used for scheduling a PUSCH” are equivalent or interchangeable.

In one embodiment, the statements that “the first DCI format is used for downlink scheduling” and “the second DCI format is used for scheduling a PUSCH” are equivalent or interchangeable.

In one embodiment, the statements that “the first DCI format is used for downlink scheduling” and “the first DCI format is used for scheduling of a downlink channel or signal” are equivalent or interchangeable.

In one embodiment, the statements that “the first DCI format is used for uplink scheduling” and “the first DCI format is used for scheduling a PUSCH” are equivalent or interchangeable.

In one embodiment, the statements that “the first DCI format is used for uplink scheduling” and “the first DCI format is used for scheduling a PUSCH and the second DCI format is used for scheduling a PDSCH” are equivalent or interchangeable.

In one embodiment, the statements that “the first DCI format is used for uplink scheduling” and “the second DCI format is used for scheduling a PDSCH” are equivalent or interchangeable.

In one embodiment, the statements that “the first DCI format is used for uplink scheduling” and “the first DCI format is used for scheduling of an uplink channel or signal” are equivalent or interchangeable.

### Embodiment 8

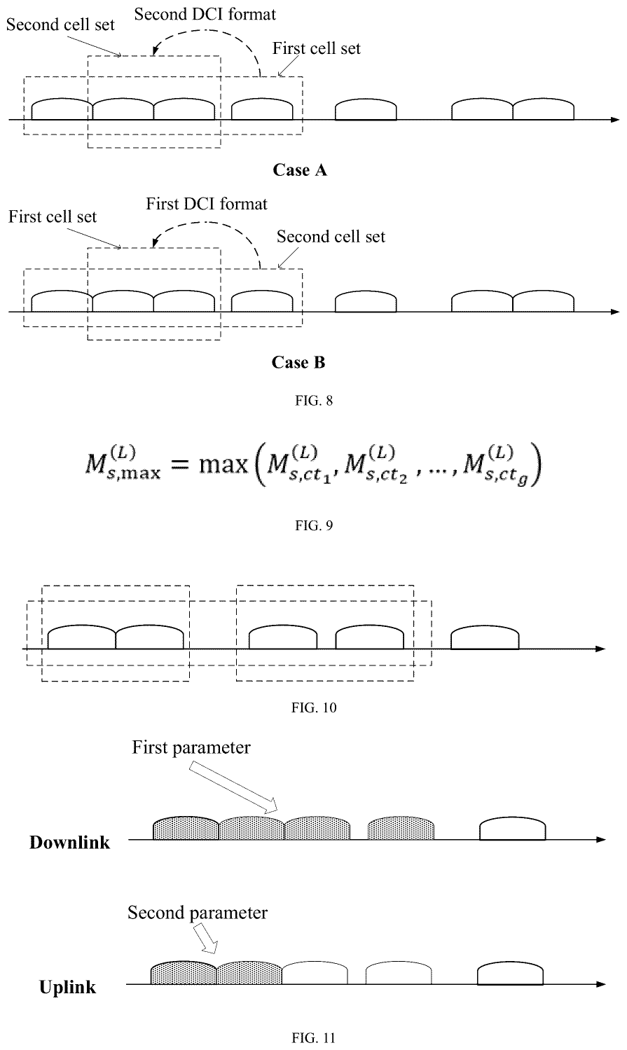

Embodiment 8 illustrates a schematic diagram of a relation between a first DCI format and a second DCI format according to one embodiment of the present application, as shown in FIG. 8. In FIG. 8, each arc-top region represents a serving cell, and each serving cell circled by dotted lines constitutes a first cell set or a second cell set; in case A, a first cell set comprises a second cell set, and the dotted line with an arrow represents a second DCI format determining the second cell set from a first cell set; in case B, a second cell set comprises a first cell set, and the dotted line with an arrow represents a first DCI format determining a first cell set from a second cell set.

In embodiment 8, when the first cell set in the present application comprises the second cell set in the present application, the second DCI format in the present application is used to determine the second cell set from the first cell set; when the second cell set comprises the first cell set, the first DCI format in the present application is used to determine the first cell set from the second cell set.

In one embodiment, statements that “when the first cell set comprises the second cell set” and “when the first DCI format is used for downlink scheduling” are equivalent or interchangeable.

In one embodiment, statements that “when the first cell set comprises the second cell set” and “when the first DCI format is used for downlink scheduling and the second DCI format is used for uplink scheduling” are equivalent or interchangeable.

In one embodiment, statements that “when the first cell set comprises the second cell set” and “when the second DCI format is used for uplink scheduling” are equivalent or interchangeable.

In one embodiment, statements that “when the second cell set comprises the first cell set” and “when the first DCI format is used for uplink scheduling” are equivalent or interchangeable.

In one embodiment, statements that “when the second cell set comprises the first cell set” and “when the first DCI format is used for uplink scheduling and the second DCI format is used for downlink scheduling” are equivalent or interchangeable.

In one embodiment, statements that “when the second cell set comprises the first cell set” and “when the second DCI format is used for downlink scheduling” are equivalent or interchangeable.

In one embodiment, the technical feature that “the second DCI format is used to determine the second cell set from the first cell set” includes the following meaning: all or partial fields comprised in the second DCI format are used to explicitly or implicitly indicate the second cell set from the first cell set.

In one embodiment, the technical feature that “the second DCI format is used to determine the second cell set from the first cell set” includes the following meaning: the second DCI format is used by the first node or the second node in the present application to determine the second cell set from the first cell set.

In one embodiment, the technical feature that “the second DCI format is used to determine the second cell set from the first cell set” includes the following meaning: all or partial fields comprised in the second DCI format are used to explicitly or implicitly indicate a serving cell comprised in the second cell set from the first cell set.

In one embodiment, the technical feature that “the second DCI format is used to determine the second cell set from the first cell set” includes the following meaning: the second DCI format comprises a reference bit map, the reference bit map comprises multiple bits, any serving cell comprised in the first cell set corresponds to a bit in the reference bit map, and a bit in the reference bit map corresponding to a serving cell in the second cell set is configured as a predefined value. In one subsidiary embodiment of the above embodiment, the pre-defined value is “1”. In one subsidiary embodiment of the above embodiment, the pre-defined value is “0”. In one subsidiary embodiment of the above embodiment, a number of bit(s) in the reference bit map is equal to a number of serving cell(s) comprised in the first cell set. In one subsidiary embodiment of the above embodiment, a number of bit(s) in the reference bit map is equal to the first quantity value. In one subsidiary embodiment of the above embodiment, the first cell set corresponds from a Most Significant bit (MSB) in the reference bit map in an ascending order or descending order according to index or identifier of comprised serving cell(s). In one subsidiary embodiment of the above embodiment, the first cell set corresponds from a Least Significant bit (LSB) in the reference bit map in an ascending order or descending order according to index or identifier of comprised serving cell(s).

In one embodiment, the technical feature that “the second DCI format is used to determine the second cell set from the first cell set” includes the following meaning: serving cell(s) comprised in the first cell set are indexed or identified in order; the second DCI format comprises a reference indicator value, the reference indicator value is used to indicate a starting index value or a starting identity value and L from the first cell set, where L is a positive integer; continuous L serving cell(s) in the first cell set starting from the starting index value or the starting identity value consists of the second cell set.

In one embodiment, the technical feature that “the first DCI format is used to determine the first cell set from the second cell set” includes the following meaning: all or partial fields comprised in the first DCI format are used to explicitly or implicitly indicate the first cell set from the second cell set.

In one embodiment, the technical feature that “the first DCI format is used to determine the first cell set from the second cell set” includes the following meaning: the first DCI format is used by the first node or the second node in the present application to determine the first cell set from the second cell set.

In one embodiment, the technical feature that “the first DCI format is used to determine the first cell set from the second cell set” includes the following meaning: all or partial fields comprised in the first DCI format are used to explicitly or implicitly indicate serving cell(s) comprised in the first cell set from the second cell set.

In one embodiment, the technical feature that “the first DCI format is used to determine the first cell set from the second cell set” includes the following meaning: the first DCI format comprises a reference bit map, the reference bit map comprises multiple bits, any serving cell comprised in the second cell set corresponds to a bit in the reference bit map, and the bit(s) in the reference bit map corresponding to a serving cell in the first cell set is (are) configured as a predefined value. In one subsidiary embodiment of the above embodiment, the pre-defined value is “1”. In one subsidiary embodiment of the above embodiment, the pre-defined value is “0”. In one subsidiary embodiment of the above embodiment, a number of bit(s) in the reference bit map is equal to a number of serving cell(s) comprised in the second cell set. In one subsidiary embodiment of the above embodiment, a number of bit(s) in the reference bit map is equal to the first quantity value. In one subsidiary embodiment of the above embodiment, the second cell set corresponds from a Most Significant bit (MSB) in the reference bit map in an ascending order or descending order according to index or identifier of comprised serving cell(s). In one subsidiary embodiment of the above embodiment, the second cell set corresponds from a Least Significant bit (LSB) in the reference bit map in ascending order or descending order according to index or identifier of comprised serving cell(s).

In one embodiment, the technical feature that “the first DCI format is used to determine the first cell set from the second cell set” includes the following meaning: serving cell(s) comprised in the second cell set are indexed or identified in order; the first DCI format comprises a reference indicator value, the reference indicator value is used to indicate a starting index value or a starting identity value and L from the second cell set, where L is a positive integer; continuous L serving cell(s) in the second cell set starting from the starting index value or the starting identity value consists (consist) of the first cell set.

### Embodiment 9

Embodiment 9 illustrates a schematic diagram of a reference quantity value according to one embodiment of the present application, as shown in FIG. 9. In FIG. 9, M_{s,max}^{(L)} denotes a reference quantity value, s denotes a first search space set, and L denotes a first aggregation level; M_{s,ct}_{₁}^{(L)}, M_{s,ct}_{₂}^{(L)}, . . . , M_{s,ct}_{_{g}}^{(L)} denotes a quantity value of PDCCH candidate(s) adopting a first aggregation level L respectively associated with serving cell(s) ct₁, ct₂, . . . , ct_{g} in a target cell set, g denotes a number of serving cell(s) comprised in a target cell set.

In embodiment 9, a reference quantity value is used to determine PDCCH candidate(s) with a first aggregation level from the first search space set in the present application, the reference quantity value being a positive integer, the first aggregation level being a positive integer; a target cell set comprises all serving cell(s) comprised in each of the W1 cell sets in the present application, and the reference quantity value is equal to a largest number of PDCCH candidate(s) with the first aggregation level respectively associated with serving cell(s) in the target cell set.

In one embodiment, the reference quantity value is not greater than 8.

In one embodiment, the reference quantity value is equal to one of 1, 2, 3, 4, 5, 6, 8.

In one embodiment, the first aggregation level is equal to one of 1, 2, 4, 8, or 16.

In one embodiment, the first aggregation level is an aggregation level supported by the first search space set.

In one embodiment, the first aggregation level is equal to an aggregation level supported by at least one serving cell in the target cell set.

In one embodiment, a number of CCE(s) occupied by a PDCCH candidate adopting the first aggregation level is equal to the first aggregation level.

In one embodiment, a number of CCEs occupied by a PDCCH candidate adopting the first aggregation level is equal to a PDCCH candidate of the first aggregation level.

In one embodiment, a PDCCH candidate adopting the first aggregation level corresponds to a PDCCH candidate of the first aggregation level.

In one embodiment, all or part of the first information block comprised in the present application is used to explicitly or implicitly indicate the first aggregation level.

In one embodiment, all or part of an information block other than the first information block in the present application is used to explicitly or implicitly indicate the first aggregation level.

In one embodiment, all or part of a configured signaling of the first search space set is used to explicitly or implicitly indicate the first aggregation level.

In one embodiment, the first aggregation level is equal to an aggregation level configured for at least one serving cell in the target cell set.

In one embodiment, the first aggregation level is configured per serving cell.

In one embodiment, the first aggregation level is configured per cell set, where the cell set comprises a serving cell that can be scheduled by a DCI or a PDCCH at the same time.

In one embodiment, the technical feature that “a reference quantity value is used to determine a PDCCH candidate adopting a first aggregation level from the first search space set” includes the following meaning: the reference quantity value is used by the first node in the present application to determine a PDCCH candidate adopting the first aggregation level from the first search space set.

In one embodiment, the technical feature that “a reference quantity value is used to determine a PDCCH candidate adopting a first aggregation level from the first search space set” includes the following meaning: the reference quantity value is used to determine a PDCCH candidate for scheduling at least one serving cell in the target cell set adopting the first aggregation level from the first search space set.

In one embodiment, the technical feature that “a reference quantity value is used to determine a PDCCH candidate adopting a first aggregation level from the first search space set” includes the following meaning: the reference quantity value is used to determine a PDCCH candidate scheduling any serving cell having a CIF value in a cell group and adopting the first aggregation level from the first search space set.

In one embodiment, the technical feature that “a reference quantity value is used to determine a PDCCH candidate adopting a first aggregation level from the first search space set” includes the following meaning: the reference quantity value is used to determine a PDCCH candidate scheduling at least one serving cell in the first cell set and adopting the first aggregation level at the same time from the first search space set.

In one embodiment, the technical feature that “a reference quantity value is used to determine a PDCCH candidate adopting a first aggregation level from the first search space set” includes the following meaning: the reference quantity value is used to determine a CCE occupied by a PDCCH candidate adopting the first aggregation level from the first search space set.

In one embodiment, the technical feature that “a reference quantity value is used to determine a PDCCH candidate adopting a first aggregation level from the first search space set” includes the following meaning: the reference quantity value is used to determine at least one CCE occupied by a PDCCH candidate adopting the first aggregation level from the first search space set.

In one embodiment, the technical feature that “a reference quantity value is used to determine a PDCCH candidate adopting a first aggregation level from the first search space set” includes the following meaning: the reference quantity value is used to determine a distribution of a PDCCH candidate adopting the first aggregation level in the first search space set.

In one embodiment, the technical feature that “a reference quantity value is used to determine a PDCCH candidate adopting a first aggregation level from the first search space set” is achieved by satisfying the following:
the first search space set s is associated with CORESET p, L denotes the first aggregation level, an index of a CCE occupied by PDCCH candidate m_{s,n}_{_{SI}}^{(L)} adopting the first aggregation level satisfies

$$L \cdot \{ ( {Y}_{p , {n}_{s , f}^{μ}} + ⌊ \frac{{m}_{s , {n}_{SI}}^{( L )} \cdot {N}_{CCE , p}}{L \cdot {M}_{s , max}^{( L )}} ⌋ + {n}_{SI} ) mod ⌊ {N}_{CCE , p} / L ⌋ \} + i$$

herein, n_{SI} denotes an index value or identifier value or indicator value corresponding to or configured by a serving cell scheduled by PDCCH candidate m_{s,n}_{_{SI}}^{(L)}, i=0, . . . , L−1, Y_{p,n}_{_{s,f}}_{^{μ}} is a value related to CORESET p, N_{CCE,p} denotes a number of CCE(s) in CORESET p, and M_{s,max}^{(L)} denotes the reference quantity value.

In one embodiment, the technical feature that “a reference quantity value is used to determine a PDCCH candidate adopting a first aggregation level from the first search space set” is achieved by satisfying the following:
the first search space set s is associated with CORESET p, L denotes the first aggregation level, an index of a CCE occupied by PDCCH candidate m_{s,n}_{_{SI}}^{(L)} adopting the first aggregation level satisfies

$$L \cdot \{ ( {Y}_{p , {n}_{s , f}^{μ}} + ⌊ \frac{{m}_{s , {n}_{SI}}^{( L )} \cdot {N}_{CCE , p}}{L \cdot {M}_{s , max}^{( L )}} ⌋ + {n}_{SI} ) mod ⌊ {N}_{CCE , p} / L ⌋ \} + i$$

herein, n_{SI} denotes an index value or identifier value or indicator value corresponding to or configured by one of the W1 cell sets scheduled by PDCCH candidate m_{s,n}_{_{SI}}^{(L)}, i=0, . . . , L−1, Y_{p,n}_{_{s,f}}_{^{μ}} is a value related to CORESET p, N_{CCE,p} denotes a number of CCE(s) in CORESET p, and M_{s,max}^{(L)} denotes the reference quantity value.

In one embodiment, the target cell set is a cell group to which any serving cell comprised in any one of the W1 cell sets belongs.

In one embodiment, the target cell set comprises all serving cell(s) in a cell group to which any serving cell comprised in any one of the W1 cell sets belongs.

In one embodiment, the target cell set comprises all serving cell(s) in a PUCCH group to which a serving cell comprised in one of the W1 cell sets belongs.

In one embodiment, the target cell set consists of serving cells from the W1 cell sets.

In one embodiment, the target cell set comprises all serving cells comprised in any one of the W2 cell sets in the present application.

In one embodiment, any serving cell comprised in any one of the W1 cell sets belongs to the target cell set.

In one embodiment, any serving cell comprised in any one of the W2 cell sets in the present application belongs to the target cell set.

In one embodiment, the target cell set comprises a serving cell not belonging to any one of the W1 cell sets.

In one embodiment, any serving cell comprised in the target cell set at least belongs to one of the W1 cell sets.

In one embodiment, all or part of the first information block is used to explicitly or implicitly indicate the target cell set.

In one embodiment, all or part comprised in an information block other than the first information block is used to explicitly or implicitly indicate the target cell set.

In one embodiment, the technical feature that “the reference quantity value is equal to a largest number of PDCCH candidate(s) with the first aggregation level respectively associated with serving cell(s) in the target cell set” includes the following meaning: the reference quantity value is equal to a largest one of quantity value(s) of PDCCH candidate(s) adopting the first aggregation level respectively associated with all serving cell(s) in the target cell set.

In one embodiment, the technical feature that “the reference quantity value is equal to a largest number of PDCCH candidate(s) with the first aggregation level respectively associated with serving cell(s) in the target cell set” includes the following meaning: the reference quantity value is equal to a largest one of quantity values of PDCCH candidate(s) adopting the first aggregation level respectively configured for all serving cell(s) in the target cell set.

In one embodiment, the technical feature that “the reference quantity value is equal to a largest number of PDCCH candidate(s) with the first aggregation level respectively associated with serving cell(s) in the target cell set” includes the following meaning: the target cell set comprises X2 serving cells, the X2 serving cells are respectively configured with X2 PDCCH candidates adopting the first aggregation level, and the reference quantity value is equal to a largest one of the X2 PDCCH candidate quantities adopting the first aggregation level.

In one embodiment, the technical feature that “the reference quantity value is equal to a largest number of PDCCH candidate(s) with the first aggregation level respectively associated with serving cell(s) in the target cell set” includes the following meaning: the target cell set comprises X2 serving cells, the X2 serving cells respectively correspond to X2 PDCCH candidate quantities adopting the first aggregation level, and the reference quantity value is equal to a largest one of the X2 PDCCH candidates adopting the first aggregation level.

In one embodiment, the technical feature that “the reference quantity value is equal to a largest number of PDCCH candidate(s) with the first aggregation level respectively associated with serving cell(s) in the target cell set” includes the following meaning: the target cell set comprises X2 serving cells, X2 being a positive integer greater than 1; the X2 serving cells respectively correspond to X2 indicator values, the X2 indicator values respectively correspond to X2 PDCCH candidate quantities adopting the first aggregation level, and the reference quantity value is equal to a largest one of X2 PDCCH candidate quantities adopting the first aggregation level.

### Embodiment 10

Embodiment 10 illustrates a schematic diagram of W1 cell sets according to one embodiment of the present application, as shown in FIG. 10. In FIG. 10, each arc-top region represents a serving cell, and each serving cell circled by dotted lines consists of one of the W1 cell sets.

In embodiment 10, one of the W1 cell sets in the present application comprises all serving cells comprised in any one of the other two cell sets in the W1 cell sets.

In one embodiment, one of the W1 cell set consists of two other cell sets in the W1 cell sets.

In one embodiment, any one of the W1 cell sets is comprised by another one of the W1 cell sets or comprises another one of the W1 cell sets.

In one embodiment, a number of serving cell(s) comprised in any one of the W1 cell sets is equal to a non-negative integral power of 2.

In one embodiment, two different cell sets in the W1 cell sets consist one of the W1 cell sets.

In one embodiment, there exists two different cell sets in the W1 cell sets respectively being a subset of one of the W1 cell sets.

In one embodiment, there only exists one of the W1 cell sets comprising all serving cells comprised in any one of another two cell sets in the W1 cell sets.

In one embodiment, there only exists any cell set in multiple cell sets in the W1 cell sets comprising all serving cells comprised in any one of another two cell sets in the W1 cell sets.

In one embodiment, all serving cells comprised in the W1 cell sets together are indexed in order according to 0, . . . , N_{cell}−1, where N_{cell} denotes a total number of all serving cells comprised in the W1 cell sets together, d^{(Q)} denotes a cell set comprising Q serving cell(s) in the W1 cell sets, and an index of a serving cell comprised in cell set d^{(Q)} satisfies

$$Q \cdot \{ ⌊ \frac{{d}^{( Q )} \cdot {N}_{cell}}{Q \cdot {M}^{( Q )}} ⌋ mod ⌊ {N}_{cell} / Q ⌋ \} + q$$

herein, q=0, . . . , Q−1, M^{(Q)} denotes a number of cell set(s) comprising Q serving cell(s) in the W1 cell sets.

In one embodiment, all serving cells comprised in the target cell set in the present application are indexed in order according to 0, . . . , N_{cell}−1, where N_{cell} denotes a total number of all serving cells comprised in the target cell set, d^{(Q)} denotes a cell set comprising Q serving cell(s) in the W1 cell sets, and an index of a serving cell comprised in cell set d^{(Q)} satisfies

$$Q \cdot \{ ⌊ \frac{{d}^{( Q )} \cdot {N}_{cell}}{Q \cdot {M}^{( Q )}} ⌋ mod ⌊ {N}_{cell} / Q ⌋ \} + q$$

herein, q=0, . . . , Q−1, M^{(Q)} denotes a number of cell set(s) comprising Q serving cell(s) in the W1 cell sets.

### Embodiment 11

Embodiment 11 illustrates a schematic diagram of a first parameter and a second parameter according to one embodiment of the present application, as shown in FIG. 11. In FIG. 11, each arc-top region in the upper half represents a serving cell that can be used for downlink, each arc-top region in the lower half represents a serving cell that can be used for uplink, serving cells represented by the arc-top regions with same filling can be scheduled by one PDCCH at the same time, a first parameter is for downlink serving cells scheduled by one PDCCH at the same time, and a second parameter is for uplink serving cells scheduled by one PDCCH at the same time.

In embodiment 11, the second information block in the present application is used to indicate a capability parameter set of a transmitter of the second information block, and a capability parameter set of a transmitter of the second information block comprises at least a first parameter and a second parameter; the first parameter is used to indicate a number of downlink serving cell(s) that is supported by the transmitter of the second information block to be scheduled by one PDCCH simultaneously, and the second parameter is used to indicate a number of uplink serving cell(s) that is supported by the transmitter of the second information block to be scheduled by one PDCCH simultaneously

In one embodiment, a capability parameter set of a transmitter of the second information block only comprises the first parameter and the second parameter.

In one embodiment, a capability parameter set of a transmitter of the second information block also comprises a parameter other than the first parameter and the second parameter.

In one embodiment, a capability parameter set of a transmitter of the second information block comprises parameters in IE “Phy-ParametersFRX-Diff”.

In one embodiment, a capability parameter set of a transmitter of the second information block comprises parameters in field “pdcch-MonitoringCA”.

In one embodiment, a capability parameter set of a transmitter of the second information block comprises parameters in field “pdcch-BlindDetectionCA”.

In one embodiment, a capability parameter set of a transmitter of the second information block comprises parameters in field “CA-ParametersNR”.

In one embodiment, a capability parameter set of a transmitter of the second information block comprises parameters in field “Phy-Parameters”.

In one embodiment, the first parameter and the second parameter are not the same.

In one embodiment, the first parameter and the second parameter are respectively for downlink and uplink.

In one embodiment, the first parameter is per band, and the second parameter is per band.

In one embodiment, the first parameter is per CC, and the second parameter is per CC.

In one embodiment, the first parameter is per band combination, and the second parameter is per band combination.

In one embodiment, the first parameter is per feature set, and the second parameter is per feature set.

In one embodiment, the first parameter is a BOOLEAN type parameter, or the first parameter is an integer, or the first parameter is a serving cell list, or the first parameter is an ENUMERATED type parameter, or the first parameter is a CHOICE type parameter, or the first parameter is a SEQUENCE type parameter.

In one embodiment, the second parameter is a BOOLEAN type parameter, or the second parameter is an integer, or the second parameter is a serving cell list, or the second parameter is an ENUMERATED type parameter, or the second parameter is a CHOICE type parameter, or the second parameter is a SEQUENCE type parameter.

In one embodiment, a transmitter of the second information block is the first node in the present application.

In one embodiment, a number of downlink serving cell(s) scheduled by one PDCCH at the same time and supported by a transmitter of the second information block can be equal to or greater than 1.

In one embodiment, a number of uplink serving cell(s) scheduled by one PDCCH at the same time and supported by a transmitter of the second information block can be equal to or greater than 1.

In one embodiment, a number of downlink serving cell(s) scheduled by one PDCCH at the same time and supported by a transmitter of the second information block is equal to or less than a number of PDSCH(s) scheduled by one PDCCH at the same time and supported by a transmitter of the second information block.

In one embodiment, a number of downlink serving cell(s) scheduled by one PDCCH at the same time and supported by a transmitter of the second information block is not greater than a number of downlink TB(s) scheduled by one PDCCH at the same time and supported by a transmitter of the second information block.

In one embodiment, a number of uplink serving cell(s) scheduled by one PDCCH at the same time and supported by a transmitter of the second information block is equal to or less than a number of PUSCH(s) scheduled by one PDCCH at the same time and supported by a transmitter of the second information block.

In one embodiment, a number of uplink serving cell(s) scheduled by one PDCCH at the same time and supported by a transmitter of the second information block is not greater than a number of uplink TB(s) scheduled by one PDCCH at the same time and supported by a transmitter of the second information block.

In one embodiment, downlink serving cell(s) scheduled by one PDCCH at the same time is (are) serving cell(s) scheduled by a same DL grant or DL assignment at the same time.

In one embodiment, downlink serving cell(s) scheduled by one PDCCH at the same time is (are) downlink serving cell(s) scheduled by a same PDCCH at most at the same time.

In one embodiment, downlink serving cell(s) scheduled by one PDCCH at the same time is (are) serving cell(s) to which all downlink channels or signals scheduled by a same PDCCH at the same time belong.

In one embodiment, downlink serving cell(s) scheduled by one PDCCH at the same time is (are) serving cell(s) to which all downlink channels or signals scheduled by a DCI format carried by a same PDCCH candidate at the same time belong.

In one embodiment, downlink serving cell(s) scheduled by one PDCCH at the same time is (are) downlink serving cell(s) scheduled by a same DCI format at the same time.

In one embodiment, downlink serving cell(s) scheduled by one PDCCH at the same time is (are) serving cell(s) to which all PDSCHs scheduled by a same PDCCH at the same time belong.

In one embodiment, downlink serving cell(s) scheduled by one PDCCH at the same time is (are) serving cell(s) to which all PDSCHs scheduled by a same DCI format at the same time belong.

In one embodiment, uplink serving cell(s) scheduled by one PDCCH at the same time is (are) serving cell(s) scheduled by a same UL grant or DL assignment at the same time.

In one embodiment, uplink serving cell(s) scheduled by one PDCCH at the same time is (are) uplink serving cell(s) that can be scheduled by a same PDCCH at most and at the same time.

In one embodiment, uplink serving cell(s) scheduled by one PDCCH at the same time is (are) serving cell(s) to which all uplink channels or signals scheduled by a same PDCCH at the same time belong.

In one embodiment, uplink serving cell(s) scheduled by one PDCCH at the same time is (are) serving cell(s) to which all uplink channels or signals scheduled by a DCI format carried by a same PDCCH candidate at the same time belong.

In one embodiment, uplink serving cell(s) scheduled by one PDCCH at the same time is (are) serving cell(s) to which all uplink channels or signals scheduled by a same DCI format at the same time belong.

In one embodiment, uplink serving cell(s) scheduled by one PDCCH at the same time is (are) serving cell(s) to which all PUSCHs scheduled by a same DCI format at the same time belong.

In one embodiment, uplink serving cell(s) scheduled by one PDCCH at the same time is (are) serving cell(s) to which all PUSCHs scheduled by a same PDCCH at the same time belong.

In one embodiment, the technical feature that “the first parameter is used to indicate a number of downlink serving cell(s) that is supported by the transmitter of the second information block to be scheduled by one PDCCH simultaneously” includes the following meaning: the first parameter is used by the first node in the present application to indicate a number of downlink serving cell(s) scheduled by one PDCCH at the same time and supported by a transmitter of the second information block.

In one embodiment, the technical feature that “the first parameter is used to indicate a number of downlink serving cell(s) that is supported by the transmitter of the second information block to be scheduled by one PDCCH simultaneously” includes the following meaning: the first parameter is used to explicitly or implicitly indicate a number of downlink serving cell(s) scheduled by one PDCCH at the same time and supported by a transmitter of the second information block.

In one embodiment, the technical feature that “the first parameter is used to indicate a number of downlink serving cell(s) that is supported by the transmitter of the second information block to be scheduled by one PDCCH simultaneously” includes the following meaning: the first parameter is used to indicate whether a transmitter of the second information block supports one PDCCH scheduling multiple downlink serving cells at the same time.

In one embodiment, the technical feature that “the first parameter is used to indicate a number of downlink serving cell(s) that is supported by the transmitter of the second information block to be scheduled by one PDCCH simultaneously” includes the following meaning: the first parameter is used to indicate a maximum number of downlink serving cell(s) scheduled by one PDCCH at the same time and supported by a transmitter of the second information block.

In one embodiment, the technical feature that “the first parameter is used to indicate a number of downlink serving cell(s) that is supported by the transmitter of the second information block to be scheduled by one PDCCH simultaneously” includes the following meaning: the first parameter is used to indicate whether a transmitter of the second information block supports one PDCCH scheduling multiple downlink serving cells at the same time and when a transmitter of the second information block supports one PDCCH scheduling multiple downlink serving cells at the same time, a maximum number of downlink serving cell(s) scheduled by one PDCCH at the same time and supported by a transmitter of the second information block is indicated.

In one embodiment, the technical feature that “the first parameter is used to indicate a number of downlink serving cell(s) that is supported by the transmitter of the second information block to be scheduled by one PDCCH simultaneously” includes the following meaning: the first parameter is used to indicate whether a transmitter of the second information block supports one PDCCH scheduling multiple downlink serving cells at the same time; when the first parameter indicates that a transmitter of the second information supports one PDCCH scheduling multiple downlink serving cells at the same time, a parameter other than the first parameter or the second parameter comprised in a capacity parameter set of a transmitter of the second information block is used to indicate a maximum number of downlink serving cell(s) scheduled by one PDCCH at the same time and supported by a transmitter of the second information block.

In one embodiment, the technical feature that “the first parameter is used to indicate a number of downlink serving cell(s) that is supported by the transmitter of the second information block to be scheduled by one PDCCH simultaneously” includes the following meaning: the first parameter is used to indicate whether a transmitter of the second information block supports one PDCCH scheduling multiple downlink serving cells at the same time; when the first parameter indicates that a transmitter of the second information block supports one PDCCH scheduling multiple downlink serving cells at the same time, a parameter other than the first parameter or the second parameter comprised in a capability parameter set of a transmitter of the second information block is used to indicate a maximum number of carriers of a downlink CA supported by a transmitter of the second information block, and a maximum number of a downlink serving cells scheduled by one PDCCH at the same time and supported by a transmitter of the second information block is equal to a maximum number of carriers of a downlink CA supported by a transmitter of the second information block.

In one embodiment, statements that “a number of downlink serving cell(s) scheduled by one PDCCH at the same time and supported by a transmitter of the second information block is equal to 1” and “a transmitter of the second information block only supports one PDCCH can only schedule a single downlink serving cell” are equivalent or interchangeable.

In one embodiment, statements that “a number of downlink serving cell(s) scheduled by one PDCCH at the same time and supported by a transmitter of the second information block is greater than 1” and “a transmitter of the second information block supports one PDCCH scheduling multiple downlink serving cells at the same time” are equivalent or interchangeable.

In one embodiment, when a transmitter of the second information block supports one PDCCH scheduling multiple downlink serving cells at the same time, a transmitter of the second information block definitely supports one PDCCH scheduling one downlink serving cell.

In one embodiment, the technical feature that “the first parameter is used to indicate a number of downlink serving cell(s) that is supported by the transmitter of the second information block to be scheduled by one PDCCH simultaneously” includes the following meaning: the first parameter is used to indicate a number of downlink serving cell(s) that is supported by the transmitter of the second information block to be scheduled by one PDCCH simultaneously per band.

In one embodiment, the technical feature that “the first parameter is used to indicate a number of downlink serving cell(s) that is supported by the transmitter of the second information block to be scheduled by one PDCCH simultaneously” includes the following meaning: the first parameter is used to indicate a number of downlink serving cell(s) scheduled by one PDCCH at the same time and supported by a transmitter of the second information block across a band combination.

In one embodiment, the technical feature that “the first parameter is used to indicate a number of uplink serving cell(s) scheduled by one PDCCH at the same time and supported by a transmitter of the second information block” includes the following meaning: the first parameter is used by the first node in the present application to indicate a number of uplink serving cell(s) scheduled by one PDCCH at the same time and supported by a transmitter of the second information block.

In one embodiment, the technical feature that “the first parameter is used to indicate a number of uplink serving cell(s) scheduled by one PDCCH at the same time and supported by a transmitter of the second information block” includes the following meaning: the first parameter is used to explicitly or implicitly indicate a number of uplink serving cell(s) scheduled by one PDCCH at the same time and supported by a transmitter of the second information block.

In one embodiment, the technical feature that “the first parameter is used to indicate a number of uplink serving cell(s) scheduled by one PDCCH at the same time and supported by a transmitter of the second information block” includes the following meaning: the first parameter is used to indicate whether a transmitter of the second information block supports one PDCCH scheduling multiple uplink serving cells at the same time.

In one embodiment, the technical feature that “the first parameter is used to indicate a number of uplink serving cell(s) scheduled by one PDCCH at the same time and supported by a transmitter of the second information block” includes the following meaning: the first parameter is used to indicate a maximum number of uplink serving cell(s) scheduled by one PDCCH at the same time and supported by a transmitter of the second information block.

In one embodiment, the technical feature that “the first parameter is used to indicate a number of uplink serving cell(s) scheduled by one PDCCH at the same time and supported by a transmitter of the second information block” includes the following meaning: the first parameter is used to indicate whether a transmitter of the second information block supports one PDCCH scheduling multiple uplink serving cells at the same time and when a transmitter of the second information block supports one PDCCH scheduling multiple uplink serving cells at the same time, a maximum number of uplink serving cell(s) scheduled by one PDCCH at the same time and supported by a transmitter of the second information block is indicated.

In one embodiment, the technical feature that “the first parameter is used to indicate a number of uplink serving cell(s) scheduled by one PDCCH at the same time and supported by a transmitter of the second information block” includes the following meaning: the first parameter is used to indicate whether a transmitter of the second information block supports one PDCCH scheduling multiple uplink serving cells at the same time; when a transmitter of the second information supports one PDCCH scheduling multiple uplink serving cells at the same time, a parameter other than the first parameter or the second parameter comprised in a capability parameter set of a transmitter of the second information block is used to indicate a maximum number of uplink serving cell(s) scheduled by one PDCCH at the same time and supported by a transmitter of the second information block.

In one embodiment, the technical feature that “the first parameter is used to indicate a number of uplink serving cell(s) scheduled by one PDCCH at the same time and supported by a transmitter of the second information block” includes the following meaning: the first parameter is used to indicate whether a transmitter of the second information block supports one PDCCH scheduling multiple uplink serving cells at the same time; when a transmitter of the second information supports one PDCCH scheduling multiple uplink serving cells at the same time, a parameter other than the first parameter or the second parameter comprised in a capability parameter set of a transmitter of the second information block is used to indicate a maximum number of carrier(s) of an uplink CA supported by a transmitter of the second information block, and a maximum number of uplink serving cell(s) scheduled by one PDCCH at the same time and supported by a transmitter of the second information block is equal to a maximum number of carrier(s) of an uplink CA supported by a transmitter of the second information block.

In one embodiment, statements that “a number of uplink serving cell(s) scheduled by one PDCCH at the same time and supported by a transmitter of the second information block is equal to 1” and “a transmitter of the second information block only supports one PDCCH can only schedule a single uplink serving cell” are equivalent or interchangeable.

In one embodiment, statements that “a number of uplink serving cell(s) scheduled by one PDCCH at the same time and supported by a transmitter of the second information block is greater than 1” and “a transmitter of the second information block supports one PDCCH scheduling multiple uplink serving cells at the same time” are equivalent or interchangeable.

In one embodiment, when a transmitter of the second information block supports one PDCCH scheduling multiple uplink serving cells at the same time, a transmitter of the second information block definitely supports one PDCCH scheduling one uplink serving cell.

In one embodiment, the technical feature that “the first parameter is used to indicate a number of uplink serving cell(s) scheduled by one PDCCH at the same time and supported by a transmitter of the second information block” includes the following meaning: the first parameter is used to indicate a number of uplink serving cell(s) scheduled by one PDCCH at the same time and supported by a transmitter of the second information block per band.

In one embodiment, the technical feature that “the first parameter is used to indicate a number of uplink serving cell(s) scheduled by one PDCCH at the same time and supported by a transmitter of the second information block” includes the following meaning: the first parameter is used to indicate a number of uplink serving cell(s) scheduled by one PDCCH at the same time and supported by a transmitter of the second information block per band combination.

### Embodiment 12

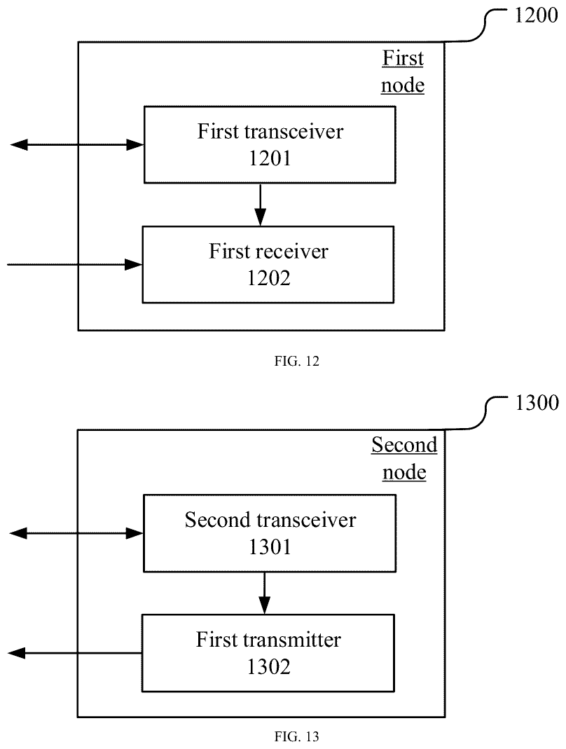

Embodiment 12 illustrates the structure diagram of a processor in a first node, as shown in FIG. 12. In FIG. 12, a processor 1200 of a first node comprises a first transceiver 1201 and a first receiver 1202. The first transceiver 1201 comprises the transmitter/receiver 456 (including the antenna 460), the receiver processor 452, the transmitting processor 455 and the controller/processor 490 in FIG. 4 of the present application; the first receiver 1202 comprises the transmitter/receiver 456 (including the antenna 460), the receiving processor 452 and the controller/processor 490 in FIG. 4 of the present application.

In embodiment 12, the first transceiver 1201 receives a first information block, the first information block is used to determine W1 cell sets, any one of the W1 cell sets comprises at least one serving cell, W1 being a positive integer greater than 1; a first receiver 1202 monitors multiple PDCCH candidates; herein, a number of serving cell(s) comprised in any one of the W1 cell sets is not greater than a first threshold, and the first threshold is a predefined or configurable positive integer; the multiple PDCCH candidates comprise at least one PDCCH candidate being monitored for a first DCI format, a first cell set is one of the W1 cell sets, and the first DCI format is used to schedule at least one serving cell comprised in the first cell set simultaneously; at least one of the multiple PDCCH candidates belongs to a first search space set, and at least one indicator value associated with the first cell set is used to determine a PDCCH candidate monitored for the first DCI format from the first search space set; a first quantity value is equal to a largest number among numbers of serving cell(s) respectively comprised in the W1 cell sets, and a size of the first DCI format is related to the first quantity value, the first quantity value being a positive integer.

In one embodiment, the first information block is used to determine W2 cell sets, and any of the W2 cell sets comprises at least one serving cell, W2 being a positive integer greater than 1; a second quantity value is equal to a largest number among numbers of serving cell(s) respectively comprised in the W2 cell sets, the second quantity value being a positive integer; the first quantity value is used to determine a first candidate size, the second quantity value is used to determine a second candidate size, and a size of the first DCI format is equal to a larger one of the first candidate size and the second candidate size.

In one embodiment, a second DCI format is a DCI format different from the first DCI format, and the second DCI format and the first DCI format are respectively used for scheduling in different link directions; the second DCI format is used to schedule at least one serving cell in a second cell set, and the second cell set comprises multiple serving cells; when the first DCI format is used for downlink scheduling, the first cell set comprises the second cell set; when the first DCI format is used for uplink scheduling, the second cell set comprises the first cell set;

In one embodiment, when the first cell set comprises the second cell set, the second DCI format is used to determine the second cell set from the first cell set; when the second cell set comprises the first cell set, the first DCI format is used to determine the first cell set from the second cell set.

In one embodiment, a reference quantity value is used to determine PDCCH candidate(s) with a first aggregation level from the first search space set, the reference quantity value being a positive integer, the first aggregation level being a positive integer; a target cell set comprises all serving cell(s) comprised in each of the W1 cell sets, and the reference quantity value is equal to a largest number of PDCCH candidate(s) with the first aggregation level respectively associated with serving cell(s) in the target cell set.

In one embodiment, one of the W1 cell sets comprises all serving cells comprised in any one of the other two cell sets in the W1 cell set.

In one embodiment, the first transceiver 1201 transmits a second information block; herein, the second information block is used to indicate a capability parameter set of a transmitter of the second information block, and the capability parameter set of the transmitter of the second information block comprises at least a first parameter and a second parameter; the first parameter is used to indicate a number of downlink serving cell(s) that is supported by the transmitter of the second information block to be scheduled by one PDCCH simultaneously, and the second parameter is used to indicate a number of uplink serving cell(s) that is supported by the transmitter of the second information block to be scheduled by one PDCCH simultaneously.

### Embodiment 13

Embodiment 13 illustrates the structure diagram of a processor in a second node, as shown in FIG. 13. In FIG. 13, a processor 1300 of a second node comprises a second transceiver 1301 and a first transmitter 1302. The second transceiver 1301 comprises the transmitter/receiver 416 (including the antenna 460), the receiving processor 412, the transmitting processor 415 and the controller/processor 440 in FIG. 4 of the present application; the first transmitter 1302 comprises the transmitter/receiver 416 (including the antenna 460), the transmitting processor 415 and the controller/processor 440 in FIG. 4 of the present application.

In embodiment 13, the second transceiver 1301 transmits a first information block, the first information block is used to determine W1 cell sets, any one of the W1 cell sets comprises at least one serving cell, W1 being a positive integer greater than 1; the first transmitter 1302 determines multiple PDCCH candidates; herein, a number of serving cell(s) comprised in any one of the W1 cell sets is not greater than a first threshold, and the first threshold is a predefined or configurable positive integer; the multiple PDCCH candidates comprise at least one PDCCH candidate being monitored for a first DCI format, a first cell set is one of the W1 cell sets, and the first DCI format is used to schedule at least one serving cell comprised in the first cell set simultaneously; at least one of the multiple PDCCH candidates belongs to a first search space set, and at least one indicator value associated with the first cell set is used to determine a PDCCH candidate monitored for the first DCI format from the first search space set; a first quantity value is equal to a largest number among numbers of serving cell(s) respectively comprised in the W1 cell sets, and a size of the first DCI format is related to the first quantity value, the first quantity value being a positive integer.

In one embodiment, the first information block is used to determine W2 cell sets, and any of the W2 cell sets comprises at least one serving cell, W2 being a positive integer greater than 1; a second quantity value is equal to a largest number among numbers of serving cell(s) respectively comprised in the W2 cell sets, the second quantity value being a positive integer; the first quantity value is used to determine a first candidate size, the second quantity value is used to determine a second candidate size, and a size of the first DCI format is equal to a larger one of the first candidate size and the second candidate size.

In one embodiment, a second DCI format is a DCI format different from the first DCI format, and the second DCI format and the first DCI format are respectively used for scheduling in different link directions; the second DCI format is used to schedule at least one serving cell in a second cell set, and the second cell set comprises multiple serving cells; when the first DCI format is used for downlink scheduling, the first cell set comprises the second cell set; when the first DCI format is used for uplink scheduling, the second cell set comprises the first cell set.

In one embodiment, when the first cell set comprises the second cell set, the second DCI format is used to determine the second cell set from the first cell set; when the second cell set comprises the first cell set, the first DCI format is used to determine the first cell set from the second cell set.

In one embodiment, a reference quantity value is used to determine PDCCH candidate(s) with a first aggregation level from the first search space set, the reference quantity value being a positive integer, the first aggregation level being a positive integer; a target cell set comprises all serving cell(s) comprised in each of the W1 cell sets, and the reference quantity value is equal to a largest number of PDCCH candidate(s) with the first aggregation level respectively associated with serving cell(s) in the target cell set.

In one embodiment, one of the W1 cell sets comprises all serving cells comprised in any one of the other two cell sets in the W1 cell set.

In one embodiment, the second transceiver 1301 receives a second information block; herein, the second information block is used to indicate a capability parameter set of a transmitter of the second information block, and the capability parameter set of the transmitter of the second information block comprises at least a first parameter and a second parameter; the first parameter is used to indicate a number of downlink serving cell(s) that is supported by the transmitter of the second information block to be scheduled by one PDCCH simultaneously, and the second parameter is used to indicate a number of uplink serving cell(s) that is supported by the transmitter of the second information block to be scheduled by one PDCCH simultaneously.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node or the second node in the present application includes but is not limited to mobile phones, tablet computers, notebooks, network cards, low-consumption equipment, enhanced MTC (eMTC) terminals, NB-IoT terminals, vehicle-mounted communication equipment, aircrafts, diminutive airplanes, unmanned aerial vehicles, telecontrolled aircrafts and other wireless communication devices. The base station or network side equipment in the present application includes but is not limited to macro-cellular base stations, micro-cellular base stations, home base stations, relay base station, eNB, gNB, Transmitter Receiver Point (TRP), relay satellites, satellite base stations, space base stations and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first transceiver, receiving a first information block, the first information block comprising all or partial fields in IE (Information Element) “ServingCellConfig”, the first information block being used to determine W1 cell sets, any one of the W1 cell sets comprising at least one serving cell, W1 being a positive integer greater than 1; and
a first receiver, monitoring multiple PDCCH (Physical Downlink Control Channel) candidates;
wherein a number of serving cell(s) comprised in any one of the W1 cell sets is not greater than a first threshold, and the first threshold is a predefined or configurable positive integer; the multiple PDCCH candidates comprising at least one PDCCH candidate being monitored for a first DCI (Downlink Control Information) format, and the first DCI format is either 0_3 or 1_3; a first cell set is one of the W1 cell sets, and the first DCI format is used to schedule at least one serving cell comprised in the first cell set simultaneously; at least one of the multiple PDCCH candidates belongs to a first search space set, and at least one indicator value associated with the first cell set is used to determine a PDCCH candidate monitored for the first DCI format from the first search space set; a first quantity value is equal to a largest number among numbers of serving cell(s) respectively comprised in the W1 cell sets, and a size of the first DCI format is related to the first quantity value, the first quantity value being a positive integer.

2. The first node according to claim 1, wherein the first information block is used to determine W2 cell sets, and any of the W2 cell sets comprises at least one serving cell, W2 being a positive integer greater than 1; a second quantity value is equal to a largest number among numbers of serving cell(s) respectively comprised in the W2 cell sets, the second quantity value being a positive integer; the first quantity value is used to determine a first candidate size, the second quantity value is used to determine a second candidate size, and a size of the first DCI format is equal to a larger one of the first candidate size and the second candidate size.

3. The first node according to claim 1, wherein the first search space set is a UE-Specific Search Set (USS set) configured with the first DCI format; a DCI format combination to which the first DCI format belongs is configured through a configuration signaling of the first search space.

4. The first node according to claim 1, wherein an indicator value associated with the first cell set is an indicator value configured for the first cell set, and any of the at least one indicator value associated with the first cell set is a non-negative integer, and all or part of the first information block is used to explicitly or implicitly indicate the at least one indicator value associated with the first cell set.

5. The first node according to claim 1, wherein a reference quantity value is used to determine PDCCH candidate(s) with a first aggregation level from the first search space set, the reference quantity value being a positive integer, the first aggregation level being a positive integer; a target cell set comprises all serving cell(s) comprised in each of the W1 cell sets, and the reference quantity value is equal to a largest number of PDCCH candidate(s) with the first aggregation level respectively associated with serving cell(s) in the target cell set.

6. The first node according to claim 1, wherein the first search space set s is associated with CORESET p, L denotes an aggregation level, n_{SI} denotes an indicator value or index value or identity value configured for the first cell set, and an index of a CCE (Control Channel Element) occupied by PDCCH candidate msn monitored by the first DCI format in the first search space set satisfies
$$L \cdot \{ ( {Y}_{p , {n}_{s , f}^{μ}} + ⌊ \frac{{m}_{s , {n}_{SI}}^{( L )} \cdot {N}_{CCE , p}}{L \cdot {M}_{s , max}^{( L )}} ⌋ + {n}_{SI} ) mod ⌊ {N}_{CCE , p} / L ⌋ \} + i$$
wherein i=0, . . . , L−1, Y_{p,n}_{_{s,f}}_{^{μ}} is a value related to CORESET (Control Resource Set) p, N_{CCE,p} denotes a number of CCE(s) in CORESET p, and M_{s,max}^{(L)} denotes a maximum number of PDCCH candidate(s) with aggregation level equal to L.

7. The first node according to claim 1, wherein the first transceiver transmits a second information block; wherein the second information block is used to indicate a capability parameter set of a transmitter of the second information block, and the capability parameter set of the transmitter of the second information block comprises at least a first parameter and a second parameter; the first parameter is used to indicate a number of downlink serving cell(s) that is supported by the transmitter of the second information block to be scheduled by one PDCCH simultaneously, and the second parameter is used to indicate a number of uplink serving cell(s) that is supported by the transmitter of the second information block to be scheduled by one PDCCH simultaneously; the capability parameter set of the transmitter of the second information block comprises parameters in field “CA-ParametersNR”, where the first parameter is per band combination and the second parameter is per band combination; the first parameter is used to indicate a maximum number of downlink serving cell(s) that is supported by the transmitter of the second information block to be scheduled by one PDCCH simultaneously; the second parameter is used to indicate a maximum number of uplink serving cell(s) that is supported by the transmitter of the second information block to be scheduled by one PDCCH simultaneously.

8. A second node for wireless communications, comprising:
a second transceiver, transmitting a first information block, the first information block comprising all or partial fields in IE (Information Element) “ServingCellConfig”, the first information block being used to determine W1 cell sets, any one of the W1 cell sets comprising at least one serving cell, W1 being a positive integer greater than 1; and
a first transmitter, determining multiple PDCCH candidates;
wherein a number of serving cell(s) comprised in any one of the W1 cell sets is not greater than a first threshold, and the first threshold is a predefined or configurable positive integer; the multiple PDCCH candidates comprising at least one PDCCH candidate being monitored for a first DCI format, and the first DCI format is either 0_3 or 1_3; a first cell set is one of the W1 cell sets, and the first DCI format is used to schedule at least one serving cell comprised in the first cell set simultaneously; at least one of the multiple PDCCH candidates belongs to a first search space set, and at least one indicator value associated with the first cell set is used to determine a PDCCH candidate monitored for the first DCI format from the first search space set; a first quantity value is equal to a largest number among numbers of serving cell(s) respectively comprised in the W1 cell sets, and a size of the first DCI format is related to the first quantity value, the first quantity value being a positive integer.

9. The second node according to claim 8, wherein the first information block is used to determine W2 cell sets, and any of the W2 cell sets comprises at least one serving cell, W2 being a positive integer greater than 1; a second quantity value is equal to a largest number among numbers of serving cell(s) respectively comprised in the W2 cell sets, the second quantity value being a positive integer; the first quantity value is used to determine a first candidate size, the second quantity value is used to determine a second candidate size, and a size of the first DCI format is equal to a larger one of the first candidate size and the second candidate size.

10. The second node according to claim 8, wherein an indicator value associated with the first cell set is an indicator value configured for the first cell set, and any of the at least one indicator value associated with the first cell set is a non-negative integer, and all or part of the first information block is used to explicitly or implicitly indicate the at least one indicator value associated with the first cell set.

11. The second node according to claim 8, wherein a reference quantity value is used to determine PDCCH candidate(s) with a first aggregation level from the first search space set, the reference quantity value being a positive integer, the first aggregation level being a positive integer; a target cell set comprises all serving cell(s) comprised in each of the W1 cell sets, and the reference quantity value is equal to a largest number of PDCCH candidate(s) with the first aggregation level respectively associated with serving cell(s) in the target cell set.

12. The second node according to claim 8, wherein the first search space set s is associated with CORESET p, L denotes an aggregation level, n_{SI} denotes an indicator value or index value or identity value configured for the first cell set, and an index of a CCE occupied by PDCCH candidate m_{s,n}_{_{SI}}^{(L)} monitored by the first DCI format in the first search space set satisfies
$$L \cdot \{ ( {Y}_{p , {n}_{s , f}^{μ}} + ⌊ \frac{{m}_{s , {n}_{SI}}^{( L )} \cdot {N}_{CCE , p}}{L \cdot {M}_{s , max}^{( L )}} ⌋ + {n}_{SI} ) mod ⌊ {N}_{CCE , p} / L ⌋ \} + i$$
wherein i=0, . . . , L−1, Y_{p,n}_{_{s,f}}_{^{μ}} is a value related to CORESET p, N_{CCE,p} denotes a number of CCE(s) in CORESET p, and M_{s,max}^{(L)} denotes a maximum number of PDCCH candidate(s) with aggregation level equal to L.

13. The second node according to claim 8, wherein the second transceiver receives a second information block; wherein the second information block is used to indicate a capability parameter set of a transmitter of the second information block, and the capability parameter set of the transmitter of the second information block comprises at least a first parameter and a second parameter; the first parameter is used to indicate a number of downlink serving cell(s) that is supported by the transmitter of the second information block to be scheduled by one PDCCH simultaneously, and the second parameter is used to indicate a number of uplink serving cell(s) that is supported by the transmitter of the second information block to be scheduled by one PDCCH simultaneously; the capability parameter set of the transmitter of the second information block comprises parameters in field “CA-ParametersNR”, where the first parameter is per band combination and the second parameter is per band combination; the first parameter is used to indicate a maximum number of downlink serving cell(s) that is supported by the transmitter of the second information block to be scheduled by one PDCCH simultaneously; the second parameter is used to indicate a maximum number of uplink serving cell(s) that is supported by the transmitter of the second information block to be scheduled by one PDCCH simultaneously.

14. A method in a first node for wireless communications, comprising:
receiving a first information block, the first information block comprising all or partial fields in IE (Information Element) “ServingCellConfig”, the first information block being used to determine W1 cell sets, any one of the W1 cell sets comprising at least one serving cell, W1 being a positive integer greater than 1; and
monitoring multiple PDCCH candidates;
wherein a number of serving cell(s) comprised in any one of the W1 cell sets is not greater than a first threshold, and the first threshold is a predefined or configurable positive integer; the multiple PDCCH candidates comprising at least one PDCCH candidate being monitored for a first DCI format, and the first DCI format is either 0_3 or 1_3; a first cell set is one of the W1 cell sets, and the first DCI format is used to schedule at least one serving cell comprised in the first cell set simultaneously; at least one of the multiple PDCCH candidates belongs to a first search space set, and at least one indicator value associated with the first cell set is used to determine a PDCCH candidate monitored for the first DCI format from the first search space set; a first quantity value is equal to a largest number among numbers of serving cell(s) respectively comprised in the W1 cell sets, and a size of the first DCI format is related to the first quantity value, the first quantity value being a positive integer.

15. The method in a first node according to claim 14, wherein the first information block is used to determine W2 cell sets, and any of the W2 cell sets comprises at least one serving cell, W2 being a positive integer greater than 1; a second quantity value is equal to a largest number among numbers of serving cell(s) respectively comprised in the W2 cell sets, the second quantity value being a positive integer; the first quantity value is used to determine a first candidate size, the second quantity value is used to determine a second candidate size, and a size of the first DCI format is equal to a larger one of the first candidate size and the second candidate size.

16. The method in a first node according to claim 14, wherein the first search space set is a USS set configured with the first DCI format; a DCI format combination to which the first DCI format belongs is configured through a configuration signaling of the first search space.

17. The method in a first node according to claim 14, wherein an indicator value associated with the first cell set is an indicator value configured for the first cell set, and any of the at least one indicator value associated with the first cell set is a non-negative integer, and all or part of the first information block is used to explicitly or implicitly indicate the at least one indicator value associated with the first cell set.

18. The method in a first node according to claim 14, wherein a reference quantity value is used to determine PDCCH candidate(s) with a first aggregation level from the first search space set, the reference quantity value being a positive integer, the first aggregation level being a positive integer; a target cell set comprises all serving cell(s) comprised in each of the W1 cell sets, and the reference quantity value is equal to a largest number of PDCCH candidate(s) with the first aggregation level respectively associated with serving cell(s) in the target cell set.

19. The method in a first node according to claim 14, wherein the first search space set s is associated with CORESET p, L denotes an aggregation level, n_{SI} denotes an indicator value or index value or identity value configured for the first cell set, and an index of a CCE occupied by PDCCH candidate m_{s,n}_{_{SI}}^{(L)} monitored by the first DCI format in the first search space set satisfies
$$L \cdot \{ ( {Y}_{p , {n}_{s , f}^{μ}} + ⌊ \frac{{m}_{s , {n}_{SI}}^{( L )} \cdot {N}_{CCE , p}}{L \cdot {M}_{s , max}^{( L )}} ⌋ + {n}_{SI} ) mod ⌊ {N}_{CCE , p} / L ⌋ \} + i$$
wherein i=0, . . . , L−1, Y_{p,n}_{_{s,f}}_{^{μ}} is a value related to CORESET p, N_{CCE,p} denotes a number of CCE(s) in CORESET p, and M_{s,max}^{(L)} denotes a maximum number of PDCCH candidate(s) with aggregation level equal to L.

20. The method in a first node according to claim 14, comprising:
transmitting a second information block;
wherein the second information block is used to indicate a capability parameter set of a transmitter of the second information block, and the capability parameter set of the transmitter of the second information block comprises at least a first parameter and a second parameter; the first parameter is used to indicate a number of downlink serving cell(s) that is supported by the transmitter of the second information block to be scheduled by one PDCCH simultaneously, and the second parameter is used to indicate a number of uplink serving cell(s) that is supported by the transmitter of the second information block to be scheduled by one PDCCH simultaneously; the capability parameter set of the transmitter of the second information block comprises parameters in field “CA-ParametersNR”, where the first parameter is per band combination and the second parameter is per band combination; the first parameter is used to indicate a maximum number of downlink serving cell(s) that is supported by the transmitter of the second information block to be scheduled by one PDCCH simultaneously; the second parameter is used to indicate a maximum number of uplink serving cell(s) that is supported by the transmitter of the second information block to be scheduled by one PDCCH simultaneously.
